(19) United States
(12) Patent Application Publication
(10) Pub. No.: US 2022/0334541 A1
(43) Pub. Date: Oct. 20, 2022

(54) ELECTRICAL CONTROL APPARATUS, PARTICULARLY FOR HOME AUTOMATION SYSTEMS

(71) Applicant: HIKE S.R.L., Milano (IT)

(72) Inventor: Riccardo Alberto MATTIOLI, San Pietro in Casale (Bologna) (IT)

(21) Appl. No.: 17/622,432

(22) PCT Filed: Jun. 26, 2020
(86) PCT No.: PCT/IB2020/056060

§ 371 Date: Dec. 23, 2021

(30) Foreign Application Priority Data
Jun. 26, 2019 (IT) 10 2019 000010125
May 14, 2020 (IT) 10 2020 000010999

(51) Int. Cl. G05B 15/02

(52) U.S. Cl. CPC G05B 15/02; G05B 2219/2642

(57) ABSTRACT

An electrical control apparatus for home automation systems includes a coupling support having first internal fixing means, at least one electromechanical device having at least one switching module having at least one controlled switch which allows selective implementation of a circuit-breaker, or deviator, or reverser configuration, a switching circuit board, at least one first electrical connection means, and an electrical device having an electronic control module having a control circuit board that has at least one second electrical connection means. The switching body has second internal fixing means interchangeably coupled to the first internal fixing means. The electronic control module controls, through the first electrical connection means and the second electrical connection means, the at least one switching module according to a command given by a user.

### TECHNICAL FIELD

The present invention is generally placed in the sector of home automation systems; in particular, the invention relates to an electrical control apparatus, particularly for home automation systems, and to an electromechanical device.

### PRIOR ART

Recent developments in home automation have made it possible to improve the quality of life in residential and work environments. The adoption of home automation systems has made it possible in particular to improve safety, simplify the design, installation, maintenance and use of technologies and reduce management costs.

Home automation has made it possible to make equipment, systems and room systems “smart.” A “smart” building, with the support of new technologies, allows for the coordinated, integrated and computerized management of technological systems (for example, air conditioning, water, gas and energy distribution, security systems, etc.) and computer and communication networks, improving management flexibility, comfort and safety and ultimately the quality of life and work in buildings.

A “smart” environment, such as a home, may be controlled by a user through appropriate user interfaces, such as buttons or keys, remote controls, voice recognition systems, etc., which make contact with a smart control system.

The different components of such a system are connected to each other and to the control system through various types of interconnection, for example the local network, or through radio waves or dedicated buses, etc.

Current home automation systems typically have distributed architecture and require hardware connections for communication between the various elements that make up the system. Communication may take place, for example, according to the KNX standard, or with CAN systems, RS485 systems, IP network connections, etc. Furthermore, two- or three-wire connections or shielded cables are used, with high costs and considerable installation times.

Disadvantageously, the electrical control apparatuses made according to the prior art have inconvenient user interfaces which are not very customizable for each home context.

Moreover, a further disadvantage of the electrical control apparatuses made according to the prior art consists in the high cost and in the long time required for the replacement of any components of the apparatus, for purposes of repairing or changing the functionality of the apparatus.

In particular, the current systems do not provide for complete integration, both as regards the switching circuits, which are normally external in appropriate electrical panels, and as regards the communication modes normally used; in particular, wired systems are used which carry both the data and the low voltage power supply, and this entails considerable costs and installation times.

A further disadvantage of the control apparatuses consists in the fact that they usually have a rear tray in which the mechanical and electronic elements are arranged, which is then inserted and/or fixed in a wall of a room. The presence of the rear tray significantly increases the size of the control apparatus and therefore requires making holes of considerable size in the walls of a room to install it.

Furthermore, disadvantageously, the presence of the tray increases the construction costs of these control apparatuses and increases the complexity of the processing required for the installation of the control apparatus in a room.

### SUMMARY OF THE INVENTION

An object of the present invention is therefore to propose an electrical control apparatus, usable in particular in home automation systems, which allows the size of the control device, the complexity of the processing required for the installation of the control device in a room, and the construction costs of this control device to be reduced, while allowing the replacement or changing of any parts of the apparatus for repairs or change of functionality of the apparatus to be done quickly and economically.

A further object of the present invention is therefore to propose an electrical control apparatus, usable in particular in home automation systems, which allows distributed home automation systems to be transformed into integrated systems and which comprises an improved and highly customizable user interface according to the needs of each user; it is not a monobloc occupying all the space, for example, within the corresponding containment box in a wall, while not allowing, for example, for all the configurations to be achieved, such as an electrical outlet and at least a switch, but rather it is a unitary module to be placed next to other objects which allows any configuration of an electrical system to be realized.

To reduce the costs of the products, and by necessity the spaces occupied by the same products for controlling buildings, the solution found was to design a new device that did not include an external support body, as the products currently on the market do, but rather in which the controlled switching body is itself the container and support of the switching device.

In short, in the present invention, the control apparatus has a new casing for containing the switch including its fixing means, bringing many advantages to the same apparatus, such as the reduction in the costs of molds for the external bodies, materials no longer present and an inevitable reduction in the space occupied.

Therefore, in a further aspect, the production of single complete switching modules is permitted, with all the switches necessary for the operation of the electrical systems and also including a power supply, in an ultra-compact external form, the realization of which was unthinkable with other known solutions.

The aforesaid and other objects and advantages are achieved, according to an aspect of the invention, by an electrical control apparatus having the features defined in claim 1, and by an electromechanical device having the features defined in claim 22. Preferred embodiments of the invention are defined in the dependent claims, the content of which is to be understood as an integral part of the present description.

Below are some example embodiments:

### Example Embodiment 1

Electrical control apparatus (1), in particular for home automation systems, comprising:
a coupling support (402) including first fixing means (78) and second fixing means (177);
at least one electromechanical device (D1) including:
a switching body (2) inside of which at least one switching module (10) is housed; said switching module (10) comprising a plurality of conductive terminals (41) arranged to allow the connection of said switching module (10) to an external electrical system (IE), and a switching circuit which includes at least one controlled switch (13) arranged to allow a selective implementation of a circuit-breaker, or deviator, or reverser configuration at said conductive terminals (41); and
a switching circuit board (21) including an electronic control circuit of the at least one controlled switch (13) and a first electrical connection means (F1);
an electrical device (D2) including:
a front panel (25); and
an electronic control module (20) including a control circuit board (11) which includes at least one conductive area (140) and a second electrical connection means (F2);
   said switching body (2) comprising third fixing means (77) arranged to be interchangeably coupled to the first fixing means (78);
   said front panel (25) comprising fourth fixing means (175) arranged to be interchangeably coupled to the second fixing means (177) of the coupling support (402);
   said electronic control module (20) being arranged to control the switching module (10) according to a command given by the user through said conductive area (140) or through an interface module (151, 152) connected to said conductive area (140);
   the plurality of conductive terminals (41) protruding from a first side of the switching body (2) and the switching circuit board (21) being arranged on a second side of the switching body (2), opposite to said first side of the switching body (2);
   the electronic control module (20) being interchangeably connected to the switching circuit board (21) through said first electrical connection means (F1) and the second electrical connection means (F2).

### Example Embodiment 2

Electrical control apparatus (1) according to the example embodiment 1, wherein the at least one electromechanical device (D1) performs at least one push-button or circuit-breaker function with respect to the external electrical system (IE), depending on the detection of a certain command given by a user.

### Example Embodiment 3

Electrical control apparatus (1) according to the example embodiment 1 or 2, wherein the first electrical connection means (F1) and the second electrical connection means (F2) are each an interlocking connector, or one is a connector and the other a conductive area.

### Example Embodiment 4

Electrical control apparatus (1) according to any one of the preceding example embodiments 1 to 3, wherein the switching body (2) comprises a first containment structure (6) wherein the switching circuit board (21) is arranged;
the electromechanical device (D1) comprising a first cover (32) of insulating material arranged to close said first containment structure (6) of said switching body (2).

### Example Embodiment 5

Electrical control apparatus (1) according to any one of the preceding example embodiments 1 to 4, wherein the control circuit board (11) is enclosed between the front panel (25) and a second cover or sealing element (22); the first cover (32) comprising at least a first opening (F1′) and the second cover or sealing element (22) comprising at least a second opening (F2′) for the passage of the first electrical connection means (F1) and/or for the passage of the second electrical connection means (F2).

### Example Embodiment 6

Electrical control apparatus (1) according to any one of the preceding embodiments 1 to 5, wherein the electromechanical device (D1) at least partially includes a voltage supply module (30) arranged to be connected to an external electric power line (SL) through electrical power terminals (41a); the voltage supply module (30) supplying at least one direct voltage output (VCC) arranged to power said electrical control apparatus (1).

### Example Embodiment 7

Electrical control apparatus (1) according to the example embodiment 6, wherein the voltage supply module (30) is connected to the switching circuit board (21) through special conductive terminals (95) passing through respective holes (96) included in the switching body (2).

### Example Embodiment 8

Electrical control apparatus (1) according to any one of the preceding example embodiments 1 to 7, wherein the conductive terminals (41) are arranged on two parallel planes (Y1, Y2) and the voltage supply module (30) is contained in a region of the electromechanical device (D1) included between said parallel planes (Y1, Y2).

### Example Embodiment 9

Electrical control apparatus (1) according to any one of the preceding example embodiments 1 to 8, wherein the control circuit board (11) comprises a first control unit (101) and the switching circuit board (21) comprises a second control unit (100); said first control unit (101) and/or said second control unit (100) being arranged to control said switching module (10) by means of a command imparted by the user.

### Example Embodiment 10

Electrical control apparatus (1) according to any one of the preceding example embodiments 1 to 9, wherein the switching body (2) includes a containment part (3) in the form of a tray, defining a second containment structure (4) arranged to contain the switching module (10).

### Example Embodiment 11

Electrical control apparatus (1) according to claim 10, wherein the switching body (2) includes a containment part (5) in the form of a tray, defining the first containment structure (6), and comprises at least one through hole (96);
wherein a first end of the through hole (96) is external to the second containment structure (4) and a second end of the through hole (96) is internal to the first containment structure (6).

### Example Embodiment 12

Electrical control apparatus (1) according to any one of the preceding example embodiments 1 to 11, wherein the conductive area (140) is arranged to generate a magnetic field or an electric field towards the outside of the electrical control apparatus (1) or to present a predetermined capacity, wherein the intensity of the magnetic field or of the electric field or the capacity of said conductive area (140) varies when a command is given by the user by touching said conductive area (140), or by the fact that the user reaches a distance lower than a predetermined threshold from the at least one conductive area (140); the variations in intensity of the magnetic field or of the electric field or of the capacity of said conductive area (140) being analyzed by the first control unit (101) and/or by the second control unit (100) or by a special measurement circuit (127) to detect a given command.

### Example Embodiment 13

Electrical control apparatus (1) according to any one of the preceding example embodiments 1 to 12, wherein the interface means (151, 152) is a display means or at least one tactile key, including a touch panel (25″), assembled by means of a welding or by means of a mechanical system for fixing to the control circuit board (11), so that the at least one electrical conductive terminal of said interfacing module (151, 152) is directly connected to at least one conductive area (140).

### Example Embodiment 14

Electrical control apparatus (1) according to any one of the preceding example embodiments 1 to 13, wherein one of said conductive areas (140) is an activation conductive area (142) associated with an activation module;
the electrical control apparatus (1) being activated when a command given by a user through the activation conductive area (142) is detected.

### Example Embodiment 15

Electrical control apparatus (1) according to any one of the preceding example embodiments 1 to 14, including a voltage monitoring circuit (102) arranged to detect the passage of the voltage (Vsl) of the external electric power line (SL) at the zero crossing point; the voltage monitoring circuit (102) being arranged to generate a voltage presence monitoring signal (Vr);
or, as an alternative to the voltage monitoring circuit (102), it includes:
   a current monitoring circuit (103) arranged to detect the passage of the current (Isl) of the external electric power line (SL) at the zero crossing point; the current monitoring circuit (103) being arranged to generate a current presence monitoring signal (Jr).

### Example Embodiment 16

Electrical control apparatus (1) according to any one of the preceding example embodiments 1 to 15, comprising a temperature sensor arranged for detecting the ambient temperature and/or a humidity sensor arranged for detecting the ambient humidity and/or a sensor for controlling the light level.

### Example Embodiment 17

Electrical control apparatus (1) according to any one of the preceding example embodiments 1 to 16, comprising a communication module (104) arranged to transmit or receive radio frequency signals through an antenna (A).

### Example Embodiment 18

Electrical control apparatus (1) according to any one of the preceding example embodiments 1 to 17, wherein the switching module (10) comprises a first fixed contact (158) and/or a second fixed contact (158′) and at least one toroid (BT) comprising inductive terminals (TI), through the central cavity of which passes the first fixed contact (158) and/or the second fixed contact (158′);
said toroid (BT) being arranged to detect and/or measure an alternating current passing through the first fixed contact (158) and/or the second fixed contact (158′), through a special measurement circuit (119), which analyzes the induced current exiting from the inductive terminals (TI) of the toroid (BT), or being arranged to generate an external power supply, through a special conversion circuit (117) that generates a current or voltage output, based on the induced current exiting from the inductive terminals (TI) of the toroid (BT) in excess relative to its own consumption.

### Example Embodiment 1B

Electromechanical device (D1) including a switching body (2) inside of which at least one switching module (10) is housed;
said switching module (10) comprising a plurality of conductive terminals (41) arranged to allow the connection of said switching module (10) to an external electrical system (IE), and a switching circuit which includes at least one controlled switch (13) arranged to allow a selective implementation of a circuit-breaker, or deviator, or reverser configuration to said conductive terminals (41) and a first fixed contact (158) and/or a second fixed contact (158′) and at least one toroid (BT) comprising inductive terminals (TI) and having a central cavity through which the first fixed contact (158) and/or the second fixed contact (158′) pass;
said toroid (BT) being arranged to detect and/or measure an alternating current passing through the first fixed contact (158) and/or the second fixed contact (158′), through a special measurement circuit (119), which analyzes the induced current exiting from the inductive terminals (TI) of the toroid (BT), or being arranged to generate an external power supply, through a special conversion circuit (117) that generates a current or voltage output, based on the induced current exiting from the inductive terminals (TI) of the toroid (BT) in excess relative to its own consumption.

### Example Embodiment 2B

Electromechanical device (D1) according to the embodiment 1B, wherein the switching module (10) comprises a first variable position contact (M1), a second variable position contact (M2), a third variable position contact (M3), a fourth variable position contact (M4), a first control circuit (138) and a second control circuit (138′),
wherein the first control circuit (138) is arranged to control the first variable position contact (M1) and the third variable position contact (M3),
the second control circuit (138′) is arranged to control the second variable position contact (M2) and the fourth variable position contact (M4).

### Example Embodiment 3B

Electromechanical device (D1) according to any one of the preceding example embodiments 1B and 2B, including a switching circuit board (21) including an electronic control circuit of the at least one controlled switch (13) and a first electrical connection means (F1).

### Example Embodiment 4B

Electromechanical device (D1) according to the example embodiment 1B, wherein the conductive terminals (41) emerge from a first side of the controlled switch (13) and control terminals (110) connected to the switching circuit board (21) emerge from a second side of the controlled switch (13) opposite the first side.

### Example Embodiment 5B

Electromechanical device (D1) according to any one of the preceding example embodiments 1B to 4B, wherein the switching body (2) comprises a first containment structure (6) wherein the switching circuit board (21) is arranged;
the electromechanical device (D1) comprising a first cover (32) made of insulating material arranged to close said first containment structure (6) of said switching body (2); said first cover (32) comprises at least a first opening (F1′) for the passage of the first electrical connection means (F1).

### Example Embodiment 6B

Electromechanical device (D1) according to the example embodiment 5B, wherein the openings (F1′) are made according to one or more geometric shapes, oval or elongated or conical.

### Example Embodiment 7B

Electromechanical device (D1) according to any one of the preceding embodiments 1B to 6B, wherein the switching body (2) includes a containment part (3) in the form of a tray, defining a second containment structure (4) arranged to contain the switching module (10) and this switching body (2) includes a containment part (5) in the form of a tray, defining the first containment structure (6), and comprises at least one through hole (96);
wherein a first end of the through hole (96) is external to the second containment structure (4) and a second end of the through hole (96) is internal to the first containment structure (6).

### Example Embodiment 8B

Electromechanical device (D1) according to any one of the preceding example embodiments 1B to 7B, wherein the electromechanical device (D1) includes at least partially a voltage supply module (30) arranged to be connected to an external electric power line (SL) through electrical power terminals (41a); the voltage supply module (30) providing at least one direct voltage output (VCC) arranged to supply said electromechanical device (D1).

### Example Embodiment 9B

Electromechanical device (D1) according to any one of the preceding example embodiments 1B to 8B, wherein the conductive terminals (41) are arranged on two parallel planes (Y1, Y2) and the voltage supply module (30) is contained in a region of the electromechanical device (D1) comprised between said parallel planes (Y1, Y2).

### Example Embodiment 10B

Electromechanical device (D1) according to any one of the preceding example embodiments 1B to 9B, including a voltage monitoring circuit (102) arranged to detect the passage of the voltage (Vsl) of the external electric power line (SL) at the zero crossing point; the voltage monitoring circuit (102) being arranged to generate a voltage presence monitoring signal (Vr);
or, as an alternative to the voltage monitoring circuit (102), it includes:
   a current monitoring circuit (103) arranged to detect the passage of the current (Isl) of the external electric power line (SL) at the zero crossing point; the current monitoring circuit (103) being arranged to generate a current presence monitoring signal (Jr).

### BRIEF DESCRIPTION OF THE DRAWINGS

The functional and structural features of some preferred embodiments of an electrical control apparatus, particularly for home automation systems, according to the invention will now be described. Reference is made to the accompanying drawings, wherein:

FIGS. 1 and 2 are respectively a first and a second perspective view, partially exploded, of an embodiment of an electrical control apparatus, flush-mounted in a seat arranged in a wall;

FIGS. 3 and 4 are respectively a first and a second perspective view, partially exploded, of a further embodiment of an electrical control apparatus according to the present invention;

FIG. 5 is a partial view, from the rear, of an electromechanical device contained in the control apparatus shown in FIG. 1;

FIG. 6 is a partially exploded side view of the electrical device contained in the control apparatus shown in FIG. 1;

FIG. 7 is a partially exploded partial side perspective view of the electrical device contained in the control apparatus shown in FIG. 1;

FIG. 8 is a partial view of the rear of a further electromechanical device contained in the control apparatus shown in FIG. 1;

FIG. 9 is a partially exploded side view of the electrical device contained in the control apparatus shown in FIG. 1;

FIG. 10 is a partially exploded partial side perspective view of the electrical device contained in the control apparatus shown in FIG. 1;

FIG. 11 is a block diagram which represents a switching module comprised in a control apparatus according to the present invention;

FIG. 12 illustrates an example embodiment of a switching circuit;

FIGS. 13 and 14 are diagrams which qualitatively illustrate waveforms for controlling the automatic disconnection of a switching circuit;

FIG. 15 illustrates the four projections of the support body of the electromechanical device according to the present invention;

FIG. 16 shows two perspective views of the support body of the electromechanical device according to the present invention;

FIG. 17 illustrates an installation perspective view with magnetic parts of an embodiment of an electrical control apparatus;

FIG. 18 illustrates a perspective view of the mechanical support for an embodiment of an electrical control apparatus;

FIGS. 19, 20 and 21 are some possible circuit embodiments including at least one toroidal coil.

### DETAILED DESCRIPTION

Before explaining in detail a plurality of embodiments of the invention, it should be clarified that the invention is not limited in its application to the construction details and configuration of the components presented in the following description or illustrated in the drawings. The invention is capable of assuming other embodiments and of being implemented or constructed in practically different ways. It should also be understood that the phraseology and terminology have a descriptive purpose and should not be understood as limiting. The use of “include” and “comprise” and their variations are to be understood as encompassing the elements set out below and their equivalents, as well as additional elements and the equivalents thereof.

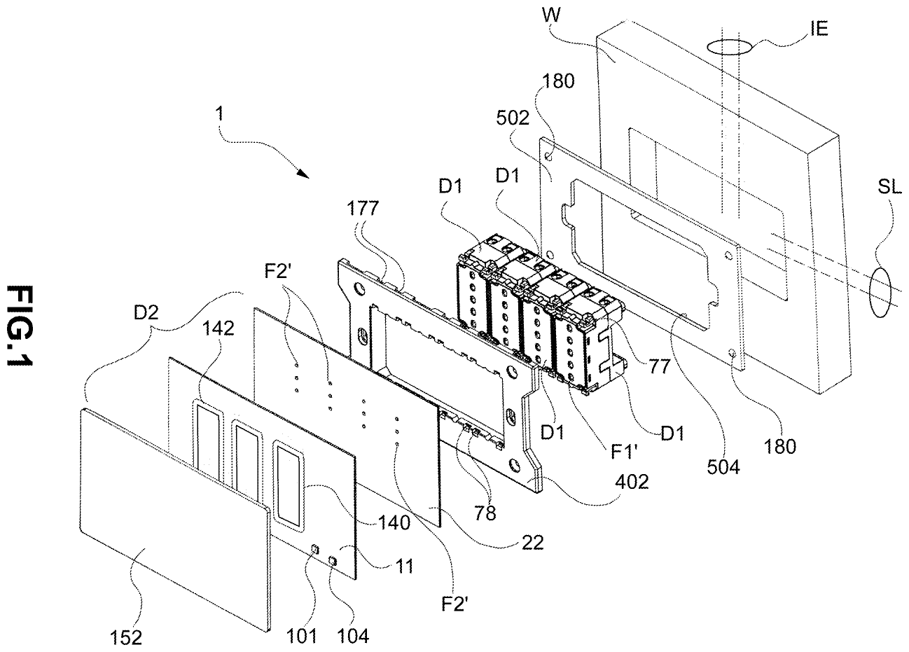

In the drawings, and in particular in FIGS. 1 to 4, 1 indicates collectively an electrical control apparatus.

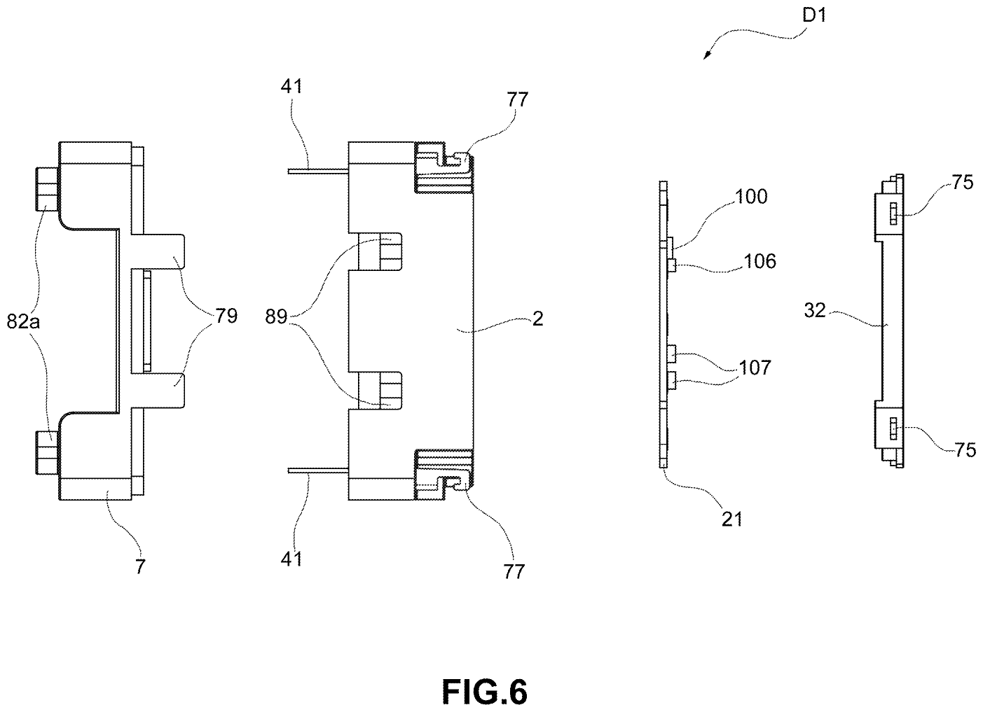

Referring further to FIGS. 6, 7, 9 and 10, the electrical control apparatus 1, particularly for home automation systems, comprises an electromechanical device D1 including a switching body 2 inside of which at least one switching module 10 is housed.

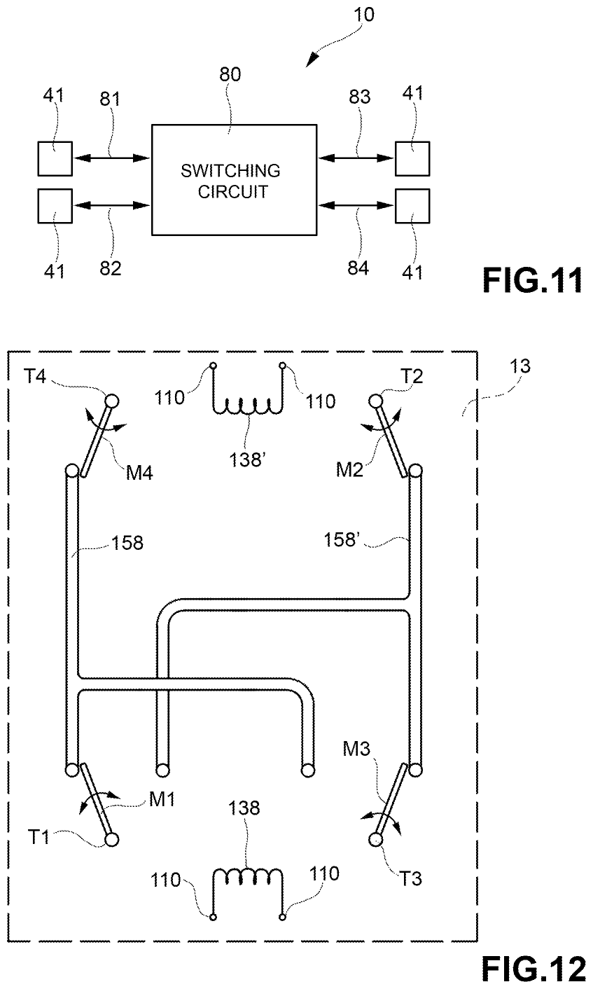

The switching module 10 comprises a plurality of conductive terminals 41 arranged to allow the connection of said switching module 10 to an external electrical system IE, and a switching circuit 80 which includes at least one controlled switch 13 arranged to allow a selective implementation of a circuit-breaker or deviator or reverser configuration to the aforesaid conductive terminals 41 (see FIG. 11).

The selective implementation of a circuit-breaker, deviator or reverser configuration to the conductive terminals 41 may be applied partially or totally, or even so that said conductive terminals 41 are totally separated from the switching circuit 80.

In other words, with a total separation of said conductive terminals it is as if the conductive terminals were separated from said switching circuit 80.

By way of explanation, when said circuit-breaker (2-way switch), deviator (3-way switch), or reverser (4-way switch) configuration of the switching circuit 80 is partially applied to the conductive terminals, or when said conductive terminals are totally separated, it is possible to allow the insulation of any device which is connected to at least one of said conductive terminals 41, for example a light bulb, from the electrical system IE connected to at least one other terminal. Due to this it will be possible to work safely on such a device, for example when one wants to remove said bulb, having the certainty that said device is not connected to said electrical system IE.

With reference to FIG. 12, “total application of the circuit-breaker configuration” means, for example, that the circuit-breaker configuration is implemented between the conductive terminals 41 connected to the switching circuit 80 through respective conductive lines 81 and 83 and/or the conductive terminals 41 connected to the switching circuit 80 through respective conductive lines 82 and 84. Or, referring to the conductive signal terminals T1, T2, T3 and T4, that the circuit-breaker configuration is implemented between conductive signal terminals T1 and T4, or, between conductive signal terminals T3 and T2, or, between conductive signal terminals T1 and T4 and between conductive signal terminals T3 and T2.

“Partial application of the circuit-breaker configuration” means, for example, that a circuit-breaker configuration is implemented between the conductive terminals 41 connected to the switching circuit 80 via respective conductive lines 81 and 83 while the circuit-breaker configuration is not implemented between the conductive terminals 41 connected to the switching circuit 80 through respective conductive lines 82 and 84 and are separated from each other, or vice versa. Or, for example, referring to the conductive signal terminals T1, T2, T3 and T4, that no configuration is implemented between the conductive signal terminals T1 and T4 or between the conductive signal terminals T3 and T2.

“Application of the total separation of the circuit-breaker configuration” means, for example, that, in reference to conductive signal terminals T1 and T4 and/or T3 and T2, between the conductive signal terminals T1, T2, T3 T4, no configuration is implemented.

On the other hand, “total application of the deviator configuration” means, for example, that the deviator configuration is implemented between the conductive terminals 41 connected to the switching circuit 80 through the respective conductive lines 81, 83 and 84. In particular, there may be at least two operating configurations, a first configuration, wherein the switching module 10 connects the conductive line 81 to the conductive line 83, and a second configuration, wherein the switching module 10 connects the conductive line 81 to the conductive line 84 thus defining the operation at the respective terminals 41, while in other configurations the conductive lines and therefore the respective terminals may be exchanged with the aforementioned operation. Or, for example, referring to the conductive signal terminals T1, T2, T3 and T4, that the deviator configuration is implemented between the conductive signal terminals T1, T4 and T2 or between the conductive signal terminals T3, T2 and T4.

“Partial application of the deviator configuration” means, for example, that the circuit-breaker configuration is implemented between the conductive terminals 41 connected to the switching circuit 80 through the respective conductive lines 81 and 83 while the conductive terminal 41 connected to the switching circuit 80 through the conductive line 84 is insulated. Or, for example, referring to the conductive signal terminals T1, T2, T3 and T4, that the circuit-breaker configuration is implemented between the conductive signal terminals T1 and T4 or T1 and T2 or between the conductive signal terminals T3 and T2 or T3 and T4.

By “application of total separation of the deviator configuration,” it is understood for example that between the conductive terminals 41 connected to the switching circuit 80 through the respective conductive lines 81, 83 and 84 there is no type of connection, therefore the terminals are separated from the configuration inside the switch. Or, for example, referring to the conductive signal terminals T1, T2, T3 and T4, that between the conductive signal terminals T1, T4 and T2 or between the conductive signal terminals T3, T2 and T4, no configuration is implemented.

On the other hand, “total application of the reverser configuration” means for example that the reverser configuration is implemented between the conductive terminals 41. Or, for example, referring to the conductive signal terminals T1, T2, T3 and T4, that the reverser configuration is implemented between the conductive signal terminals T1, T2, T3 and T4.

In particular, there may be at least two operating configurations, a first configuration wherein the switching module 10 connects the conductive line 81 to the conductive line 83 and the conductive line 82 to the conductive line 84 and a second configuration the switching module 10 connects the conductive line 81 to the conductive line 84 and the conductive line 82 to the conductive line 83, thus defining the operation at the respective terminals 41, while in other configurations the conductive lines and therefore the respective terminals may be exchanged with the aforementioned operation. Or, for example, referring to the conductive signal terminals T1, T2, T3 and T4, in a first configuration the switching module 10 connects the conductive signal terminals T1, T4 and conductive signal terminals T3, T2 and in a second configuration the switching module 10 connects the conductive signal terminals T1, T2 and the conductive signal terminals T3, T4.

“Partial application of the reverser configuration” means, for example, that the circuit-breaker configuration is implemented between the conductive terminals 41 connected to the switching circuit 80 through respective conductive lines 81 and 83 or that the deviator configuration is applied between the conductive terminals 41 connected to the switching circuit 80 through respective conductive lines 81, 83 and 84. Or, for example, referring to the conductive signal terminals T1, T2, T3 and T4, that only the circuit-breaker configuration is implemented between the conductive signal terminals T1 and T4 and/or between the conductive signal terminals T3 and T2.

“Application of the total separation of the reverser configuration” means for example that between the conductive terminals 41 there is no type of connection, therefore the terminals are separated from the internal configuration of the switch. Or, referring to the conductive signal terminals T1, T2, T3 and T4, that no configuration is implemented between the conductive signal terminals T1, T2, T3 T4.

In other configurations the conductive lines, and thus the respective terminals, may be permutated with the aforesaid operation.

In a simplified configuration the signal terminals T1, T2, T3 and T4 may be connected directly to the conductive terminals 41 or they may be the same terminals 41.

With total application of the configuration, whatever it is, the switching circuit applies to the signal terminals T1, T2, T3 and T4, or to the conductive terminals 41, the configuration for which it has been designated.

With partial application of the configuration, whatever it is, the switching circuit may vary its internal switching configuration and apply it to the signal terminals T1, T2, T3 and T4, or to the conductive terminals 41, also by permuting the same signal terminals T1, T2, T3 and T4, or the conductive terminals 41.

With application of total separation of the configuration, whatever it may be, the switching circuit does not apply to the signal terminals T1, T2, T3 and T4 or to the conductive terminals 41 the configuration for which it has been designated, despite retaining within it the aforesaid switching circuit, which may also be controlled, but not applied to the signal terminals T1, T2, T3 and T4, or to the conductive terminals 41.

It is therefore evident that the conductive terminals 41 may be independent of each other.

There is therefore no fixed connection between two terminals within the non-modifiable switch, which joins at least two of said terminals, since it would not be possible to carry out any previously described configuration.

The electromechanical device D1 further includes a switching circuit board 21 including an electronic control circuit of the at least one controlled switch 13 and a first electrical connection means F1.

Obviously, this structure of the electromechanical device D1, implements a new structural concept wherein the switching body 2 is itself the structural support body, therefore, there is no longer the need for an external container of the switching circuit(s), eliminating therefore materials, molds, costs, etc., and thus obtaining a further significant reduction in the volumes occupied by the electromechanical device D1.

The control apparatus 1 further comprises an electrical device D2 which includes an electronic control module 20 including a control circuit board 11 which comprises at least second electrical connection means F2.

In further embodiments the electrical device D2 may also include a front panel 25. Or in addition, the electrical device D2 may also comprise at least one conductive area 140.

Preferably, the electronic control module 20 may be interchangeably connected to the switching circuit board 21 by means of the first electrical connection means F1 and the second electrical connection means F2.

The coupling support 402 may comprise first internal fixing means 78 and the switching body 2 may comprise second internal fixing means 77, arranged to be coupled interchangeably.

The front panel 25 (in the embodiments where it is present), or the electrical device D2, may comprise second external fixing means 175 and the coupling support 402 may comprise first external fixing means 177 arranged to be coupled interchangeably.

The first and second internal fixing means 78, 77 and the first and second external fixing means 177, 175 (when present) may be mechanical fixing means, for example a snap.

Preferably, the electronic control module 20 may be arranged to control the switching module 10 according to a command given by the user through said conductive area 140 or through an interface module 151 and/or 152 connected to the conductive area 140.

The electronic control module 20 may be arranged to control, through the first electrical connection means F1 and the second electrical connection means F2 associated with said switching module 10, the at least one switching module 10 as a function of a command given by the user.

This configuration may therefore control a plurality of switching modules 10 by including a plurality of electrical connection means F2 associated with the switching modules 10, each including at least first electrical connection means F1.

The plurality of conductive terminals 41 emerge from a first side of the switching body 2 and the switching circuit board 21 is arranged on a second side of the switching body 2, opposite the first side of the switching body 2.

Preferably, the at least one electromechanical device D1 may perform at least one push-button or switch function with respect to the external electrical system IE, according to the detection of a certain command given by a user.

In a further aspect, the first electrical connection means F1 and the second electrical connection means F2 may each be a snap connector, or one may be a connector and the other a conductive area.

Or, the first electrical connection means F1 and the second electrical connection means F2 may each be optical or radio frequency data transmission systems.

The switching body 2 of the electromechanical device D1 may include a containment structure 4 in the form of a tray, defining a cavity 3, arranged to contain the switching module 10 and may include a containment part 5 in the form of a tray, defining a cavity 6, intended to contain the switching circuit board 21; moreover the switching body 2 may have at least one through hole 96 outside the containment structure 4 and inside the cavity 6.

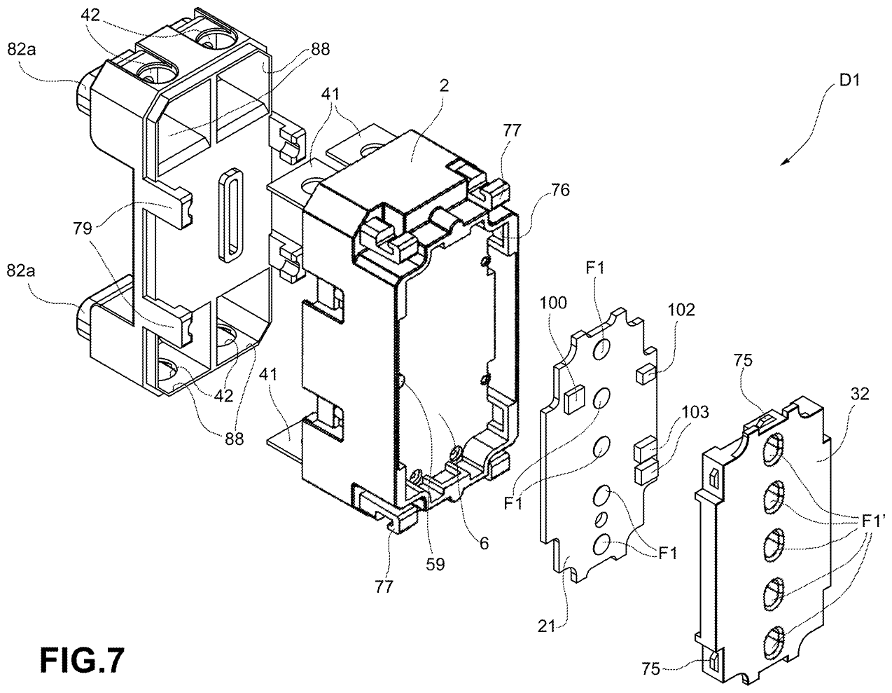

As may be seen in FIG. 7, the electromechanical device D1 may comprise a first cover 32 of insulating material arranged to close the cavity 6 of the switching body 2.

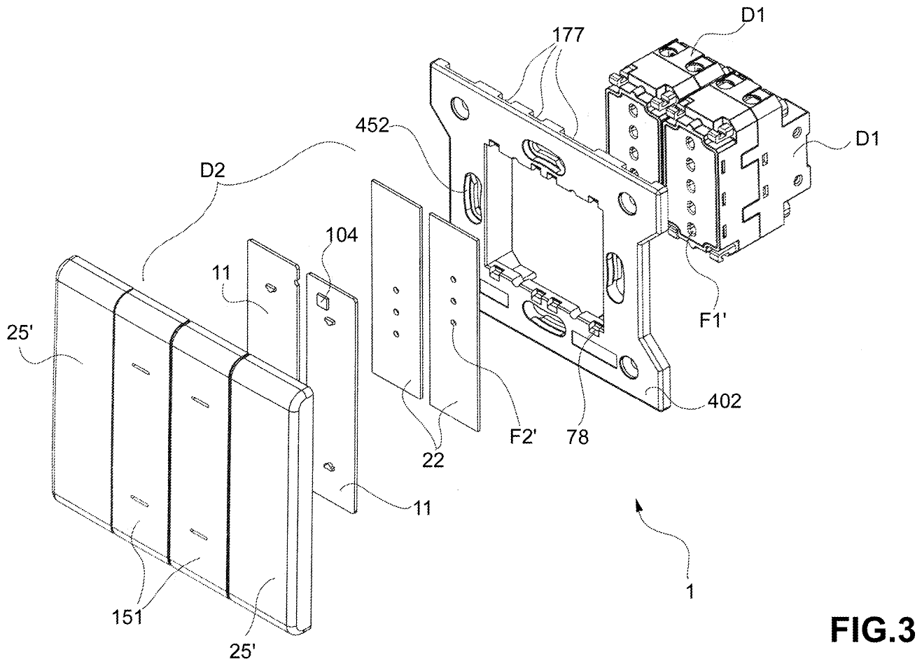

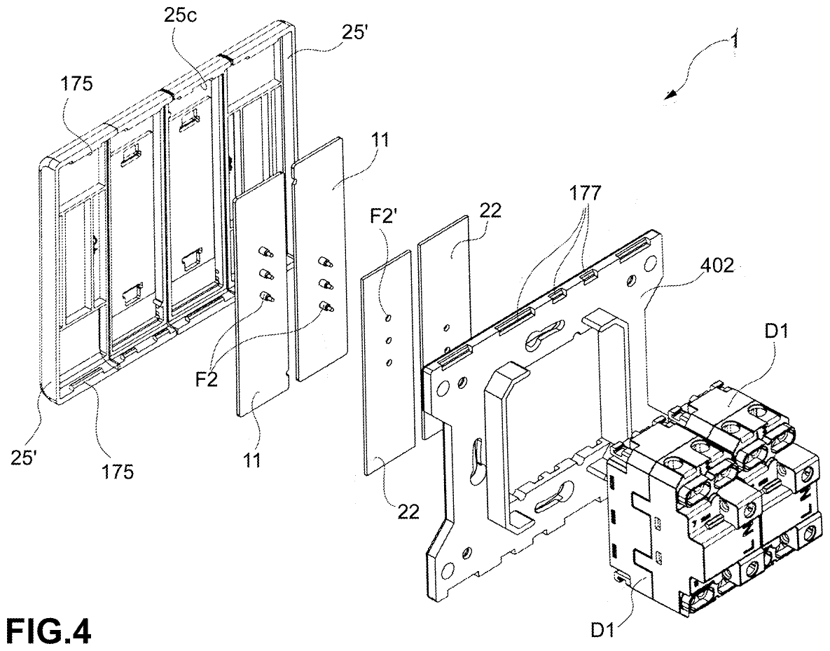

Looking now at FIG. 3 or FIG. 4, the control circuit board 11 may be enclosed between the front panel 25 and a second cover or sealing element 22. The first cover 32 comprises at least a first opening F1′ and the second cover or sealing element 22 comprises at least a second opening F2′, respectively, for the passage of the first electrical connection means F1 and/or for the passage of the second electrical connection means F2.

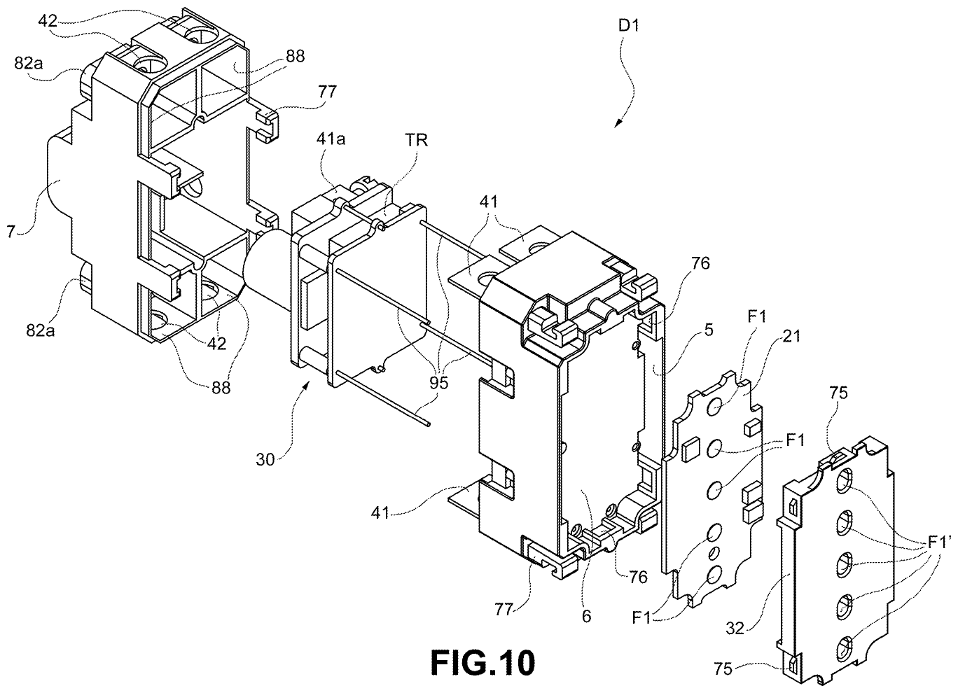

As illustrated in FIGS. 7 and 10, the first electrical connection means F1 may be arranged on the switching circuit board 21 so as to be exposed towards a front opening 5 of the switching body 2. This allows the first electrical connection means F1 to be joined to the second electrical connection means F2.

To increase the safety of the electromechanical device(s) D1 coupled to the coupling support 402 and to ensure that they do not accidentally unhook, the second cover or sealing element 22 may include external brackets so as to be positioned in the spaces created by the second internal fixing means 77 and the same switching body 2 to avoid displacement of the same second internal fixing means 77.

Expediently, the second internal fixing means 77 may be, for example, a hook pin which engages the first internal fixing means 78.

Preferably, the second internal fixing means 77 and the first internal fixing means 78 may be made so as to allow the fixing of the electromechanical device(s) D1 to the coupling support 402 on the surface facing a delimiting wall W, while the first external fixing means 177 and the second external fixing means 175 may be made so as to allow the fixing of the electronic device(s) D2 to the coupling support 402. The electromechanical devices D1 may have a longitudinal dimension so as not to allow the front insertion on the coupling support 402.

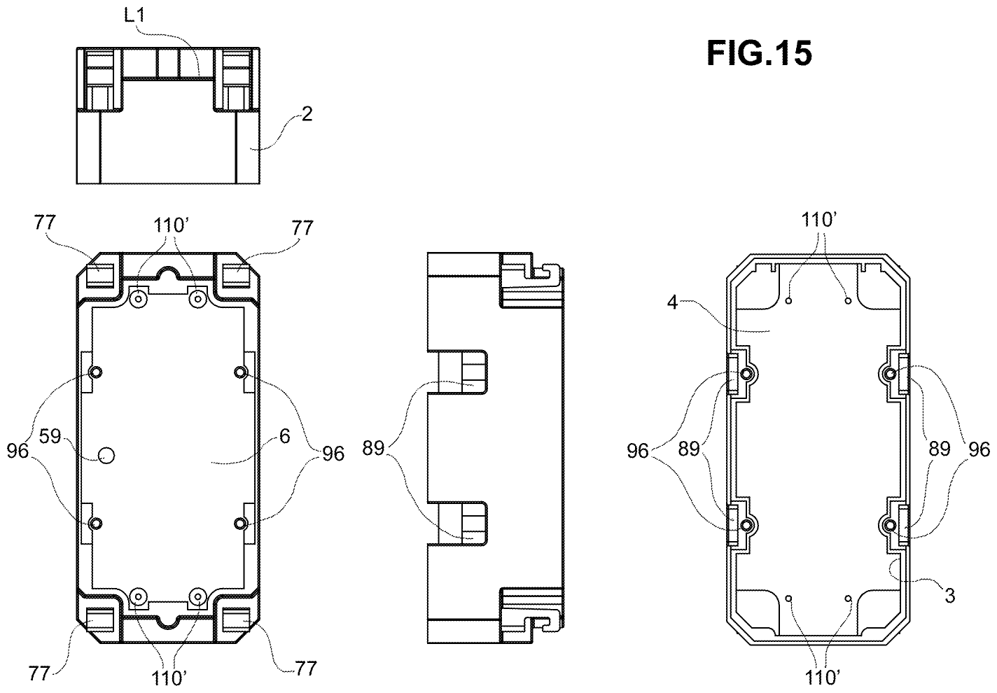

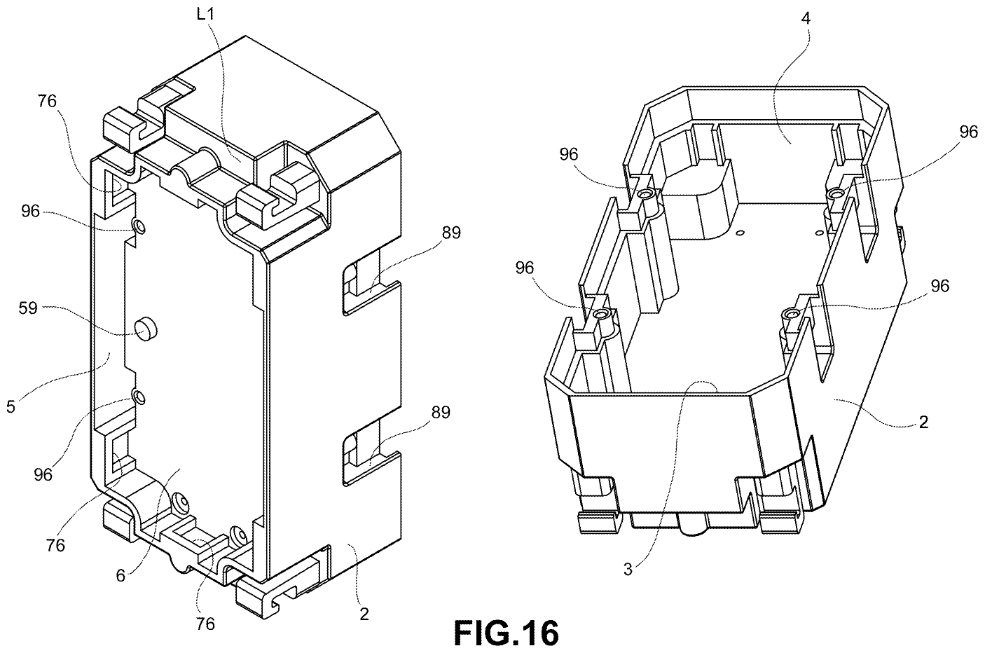

Therefore the electromechanical device(s) D1 may be coupled to the coupling support 402 either with a front insertion, in which case the second internal fixing means of the electromechanical device D1 must be shaped differently so as to lock the same electromechanical device D1 on the coupling support 402, or opposite, so that a plane L1 (see FIGS. 15 and 16) is in contact with the surface of the coupling support 402 facing the delimitation wall W.

Expediently, the first and second internal fixing means 77, 78, and the first and second external fixing means 175 and 177 may also allow the coupling of other devices (such as electrical sockets, connector modules, etc., not shown) in the installation direction of the electronic device(s) D2, thus making the installation system highly flexible.

As may be seen in FIG. 10, the electromechanical device D1 may at least partially include a voltage supply module 30 arranged to be connected to an external electric power line SL through electrical power terminals 41a.

The external electric power line SL is for example a high voltage line (e.g. 240 V AC, 50 or 60 Hz).

The voltage supply module 30 may therefore provide at least one direct current voltage output VCC arranged to supply the electrical control apparatus 1.

The voltage supply module 30 may be connected to the switching circuit board 21 through special conductive terminals 95 passing through respective holes 96 comprised in the switching body 2.

Furthermore, the conductive terminals 41 may be arranged on two parallel planes Y1, Y2 and the voltage supply module 30 may be contained in a region of the electromechanical device D1 between the parallel planes Y1, Y2 to minimize the space occupied, and may contain a first power supply circuit board 31a including the electrical power terminals 41a and a second power supply circuit board 31b arranged parallel to the first power supply circuit board 31a.

Finally, the electronic control module 20 and the voltage supply module 30 may be separated electrically and mechanically from the conductive terminals 41.

In addition, the switching circuit board 21 may be connected to the second power supply circuit board 31b through the special conductive terminals 95 or through the output terminals of the transformer TR themselves.

Expediently, the voltage supply module 30 may comprise a transformer TR arranged on the second power supply circuit board 31b.

In particular the first power supply circuit board 31a may contain a filter circuit 116 (not shown) of the external electric power line SL, including at least one inductor and at least one capacitor and the second power supply circuit board 31b may contain an electronic circuit to control the power supply and to control the transformer TR (see FIG. 10), so as to guarantee an output controlled by the same transformer TR or vice versa.

In particular, the first power supply circuit board 31a and the second power supply circuit board 31b may be assembled together by means of two linear conductors 94 which connect the output of the filtering circuit 116 of the first power supply circuit board 31a with the input of the electronic circuit for power supply and transformer TR control on the second supply circuit board 31b and at least one linear conductor 94 or at least one resistor RE of the voltage monitoring circuit 102 and/or of the current monitoring circuit 103, which may then connect directly to the switching circuit board 21 through the through holes 96.

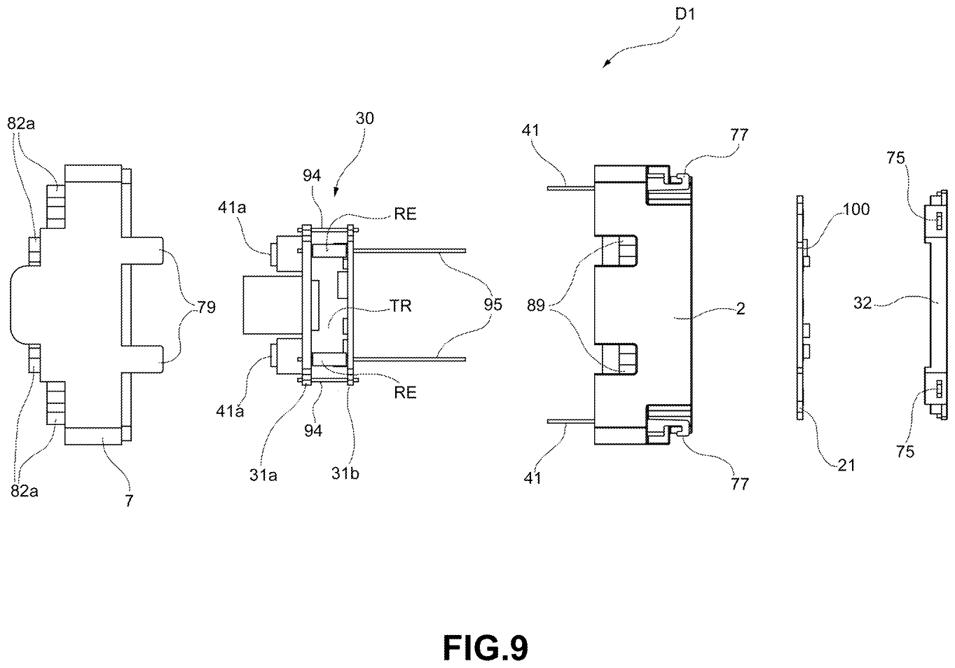

The special conductive terminals 41 may therefore be mechanical conductive terminals (as shown in FIGS. 9 and 10).

In a further aspect, the control circuit board 11 may comprise a first control unit 101 and the switching circuit board 21 may comprise a second control unit 100.

The first control unit 101 and/or the second control unit 100 may be arranged to control the switching module 10 in response to a command given by the user.

The interface means 152 may be a display means, for example such as a mobile phone, tablet or smartphone, and may include a touch panel 25″ and the interface means 151 may be at least a tactile key, assembled by welding or by a mechanical fastening system to the control circuit board 11, so that at least one electrical conductive terminal of the interface module 151 and/or 152, is directly connected to at least one conductive area 140, included in the control circuit board 11.

In particular, if the interface module 151 and/or 152 is a key, it may directly control the switching circuit 80 associated with said key or it may control said switching module through the first control unit 101 and/or the second control unit 100.

Instead, the aforesaid tactile panel 25″ may be arranged to create a layer of dielectric material intended for the operation of the at least one conductive area 140 and fixed to the control circuit board 11 by means of a layer of adhesive material.

The electromechanical device D1 may further comprise a closure cap 7 of insulating material adapted to close the rear part of the switching body 2.

Advantageously, the electrical device D2 may be coupled to the coupling support 402 by also inserting it parallel to the same coupling support 402 and locked with the second external fixing means 175, formed for example as coupling hooks.

The electrical device D2 may be centered, for example, on a lateral translation axis by using at least one pin 176 coupled to a respective cavity 178, the centering tolerance of which corresponds to the distance between the pin 176 and the same cavity 178 or from the second external fixing means 175.

Advantageously, the control circuit board 11 may be contained in a special cavity 25c made in the front panel 25.

The electrical device D2 may be centered, for example, on a longitudinal axis of translation through the construction of two planes inclined towards the outside of the coupling support 402 and included in the first external fixing means 177, made with opposite inclinations and two other inclined planes, included in the front panel 25, made in such a way that they may slide on the planes of the first external fixing means 177.

Therefore, the electrical device D2 is positioned at the point of least mechanical effort, centering itself relative to the same coupling support 402.

Similarly, the extraction of the electrical device D2 from the coupling support 402 may be obtained by pushing the electrical device D2 longitudinally, i.e. upwards or downwards, until the second external fixing means 175 is separated from the first external fixing means 177 and therefore by tilting the same electrical device D2 so as to move it away from the coupling support 402.

To facilitate this operation and not to cause damage or breakage to the electrical connection means F1 and/or F2, the opening(s) F1′ may be made in various geometric shapes, for example they may be oval or elongated or even conical, in such a way as to avoid physical contact, during insertion or removal, between the coupling support 402 and the electrical connection means F1 and/or F2.

In particular, it is the first electrical connection means F1 which may be exposed from the first opening F1′ and it is the second electrical connection means F2 which may be inserted into the first opening F1′, or vice versa.

Expediently, there may be several electrical connection means F1, and corresponding openings F1′, connected to the same electrical signals and arranged so as to be able to rotate the same electromechanical device D1 both upwards and downwards, simplifying the installation thereof.

By way of example, the electrical connection means positioned towards the outside may be connected to the ground reference, the two connection means adjacent to them may be connected to data communication signals and the central electrical connection means may be connected to the continuous power supply (for example 5V).

In a possible configuration wherein in the electrical device D2 three electrical connection means are used, one for ground reference, one for data communication and one for power, and in the electromechanical device D1 there are five electrical connection means (as seen for example in FIGS. 7 and 10), made symmetrical relative to the first central electrical connection means F1, the orientation of the electrical device D2 being independent of the orientation of the electromechanical device D1 coupled to the coupling support 402, both upwards and downwards, simplifying the final assembly of the electrical control apparatus 1.

Obviously, this is possible even if there are only two or more electrical connection means, keeping the correspondence of the electrical connection means rotated either upwards or downwards between the electrical device D2 and the electromechanical device D1.

In a further aspect, preferably, the switching circuit board 21 may include one or more capacitors 107 arranged to guarantee the operation of the electromechanical device D1 even in the absence of power on the external electric power line SL for a period of time which may be calculated on the basis of the load of the same capacitors.

As may be seen in FIGS. 7 and 10, the at least one controlled switch 13 may include conductive terminals 41 exiting from a first side of the controlled switch 13 and control terminals 110 exiting from a second side of the controlled switch 13 opposite to the first side. In particular, the control terminals 110 are connected to the switching circuit board 21 and the conductive terminals 41 are connected to the external electrical system IE.

By analyzing in detail the characteristics of the conductive area 140, the latter may be arranged to generate a magnetic field or an electric field towards the outside of the electrical control apparatus 1 or it may have a predetermined capacity. In this case, the intensity of the magnetic field or the electric field or the capacity of said conductive area 140 varies when a command is given by the user by touching said conductive area 140, or by the user reaching a distance less than a predetermined threshold from the at least one conductive area 140. The intensity variations of the magnetic field or of the electric field or of the capacity of said conductive area 140 are analyzed by the first control unit 101 and/or by the second control unit 100 or by a special measurement circuit 127 to detect a command given.

In other words, the conductive area 140 may perform the function of a touch sensor or proximity sensor.

The conductive area 140 may be arranged on an outer surface or an inner layer of the control circuit board 11.

In an embodiment not shown, the conductive area 140 may be used as a connection area for an interface module 151 and/or 152 suitable to allow a user to give a command to the electrical control apparatus 1.

The interface module 151 and/or 152 may be expediently assembled by welding or by a mechanical fixing system, for example through a connector, to the control circuit board 11, so that the at least one electrical conductive terminal of said module interface 151 and/or 152 is directly connected to at least one conductive area 140.

Preferably, but not necessarily, the conductive area 140 has an areola shape or a quadrilateral frame and, in the case of a plurality of conductive areas 140, the latter are arranged parallel to each other with a distance d. This distance d is provided to avoid any interference between them.

Looking now at FIG. 12, this figure partially illustrates an embodiment of a switching module 10, for the implementation of a switching circuit.

In a possible configuration, the switching module 10 may comprise a first fixed contact 158 and a second fixed contact 158′, a first variable position contact M1, a second variable position contact M2, a third variable position contact M3, a fourth variable position contact M4, a first control circuit 138 and a second control circuit 138′.

The first control circuit 138 may be arranged to control the first variable position contact M1 and the third variable position contact M3.

The second control circuit 138′ may instead be arranged to control the second variable position contact M2 and the fourth variable position contact M4.

The integrated electromechanical device 1 further comprises a plurality of conductive signal terminals T1, T2, T3, T4.

The plurality of conductive signal terminals T1, T2, T3, T4 comprise a first conductive signal terminal T1 connected to the first variable position contact M1, a second conductive signal terminal T2 connected to the second variable position contact M2, a third conductive signal terminal T3 connected to the third variable position contact M3 and a fourth conductive signal terminal T4 connected to the fourth variable position contact M4.

At least one second conductive control terminal 110 may be connected to the first control circuit 138 and to the second control circuit 138′, if present.

The first conductive signal terminal T1, in a first predetermined condition, is electrically connected to the second fixed contact 158′ and in a second predetermined condition is connected to the first fixed contact 158 through said first variable position contact M1. The first control circuit 138 controls the passage from the first condition to the second condition, and vice versa.

The third conductive signal terminal T3 in a first predetermined condition is electrically connected to the first fixed contact 158 and in a second predetermined condition is connected to the second fixed contact 158′ through said third variable position contact M3.

The first control circuit 138 controls the passage from the first condition to the second condition, and vice versa.

The second conductive signal terminal T2 and the second fixed contact 158′, in a predetermined conductive condition, are electrically connected to each other through said second variable position contact M2 and, in a predetermined insulating condition, are not electrically connected to each other. The second control circuit 138′ controls the passage from the conductive condition to the insulating condition, and vice versa.

The fourth conductive signal terminal T4 and the first fixed contact 158, in a predetermined conductive condition, are electrically connected to each other through said fourth variable position contact M4 and, in a predetermined insulating condition, are not electrically connected to each other. The second control circuit 138′ controls the passage from the conductive condition to the insulating condition, and vice versa.

The first variable position contact M1, the second variable position contact M2, the third variable position contact M3, the fourth variable position contact M4, the first fixed contact 158 and the second fixed contact 158′ are made so that, in any positioning configuration of the first variable position contact M1, the second variable position contact M2, the third variable position contact M3 and the fourth variable position contact M4, the first fixed contact 158 and the second fixed contact 158′ are always in a condition of electrical insulation between them.

In a simplified deviator configuration (3-way switch) the switching module 10 may comprise a first fixed contact 158 and a second fixed contact 158′, a first variable position contact M1 and a first control circuit 138.

The first control circuit 138 may be arranged to control the first variable position contact M1.

The integrated electromechanical device 1 further comprises a plurality of conductive signal terminals T1, T2 and T4.

At least one second conductive control terminal 110 may be connected to the first control circuit 138.

The first conductive signal terminal T1, in a first predetermined condition, is electrically connected to the first fixed contact 158 and in a second predetermined condition the first conductive signal terminal T1 is connected to the second fixed contact 158′.

The electrical connection between the first conductive signal terminal T1 and the first fixed contact 158 or the second fixed contact 158′ is obtained through the first variable position contact M1.

The fourth terminal T4 is connected to the first fixed contact 158 and the second terminal T2 is connected to the second fixed contact 158′, or in a variant, the switching module 10 may comprise a second variable position contact M2, a fourth variable position contact M4 and a second control circuit 138′ arranged to control said second variable position contact M2 and said fourth variable position contact M4; the electrical connection between the fourth conductive signal terminal T4 and the first fixed contact 158 is obtained through the fourth variable position contact M4 and the electrical connection between the second conductive signal terminal T2 and the second fixed contact 158′ is obtained through the second variable position contact M2.

The first variable position contact M1, the first fixed contact 158 and the second fixed contact 158′ are made so that, in any positioning configuration of the first variable position contact M1, the first fixed contact 158 and the second fixed contact 158′ are always in a condition of electrical insulation between them.

The first control circuit 138 controls the passage from the first condition to the second condition, and vice versa.

In a double circuit-breaker configuration (double 2-way switch) the switching module 10 may comprise a first fixed contact 158 and a second fixed contact 158′, a first variable position contact M1, a second variable position contact M2, a first control circuit 138 and a second control circuit 138′.

The first control circuit 138 may be arranged to control the first variable position contact M1 and the second control circuit 138′ may be arranged to control the second variable position contact M2.

The integrated electromechanical device 1 further comprises a plurality of conductive signal terminals T1, T2, T3 and T4.

At least one second conductive control terminal 110 may be connected to the first control circuit 138 and to the second control circuit 138′.

The first conductive signal terminal T1, in a first predetermined condition, is electrically connected to the first fixed contact 158, and in a second predetermined condition the first conductive signal terminal T1 is not connected to the first fixed contact 158.

The second conductive signal terminal T2, in a first predetermined condition, is electrically connected to the second fixed contact 158′ and in a second predetermined condition the second conductive signal terminal T2 is not connected to the second fixed contact 158′.

The electrical connection between the first conductive signal terminal T1 and the first fixed contact 158 is obtained through the first variable position contact M1.

The electrical connection between the second conductive signal terminal T2 and the second fixed contact 158′ is obtained through the second variable position contact M2.

The fourth terminal T4 is connected to the first fixed contact 158 and the third terminal T3 is connected to the second fixed contact 158′.

The first variable position contact M1, the second variable position contact M2, the first fixed contact 158 and the second fixed contact 158′ are made so that, in any positioning configuration of the first variable position contact M1 and the second variable position contact M2, the first fixed contact 158 and the second fixed contact 158′ are always in a condition of electrical insulation between them.

The first control circuit 138 and the second control circuit 138′ control the passage from the first condition to the second condition, and vice versa.

In a further reverser configuration (4-way switch), the switching module 10 may comprise a first fixed contact 158 and a second fixed contact 158′, a first variable position contact M1, a third variable position contact M3 and a first control circuit 138.

The first control circuit 138 may be arranged to control the first variable position contact M1 and the third variable position contact M3.

The integrated electromechanical device 1 further comprises a plurality of conductive signal terminals T1, T2, T3 and T4.

At least one second conductive control terminal 110 may be connected to the first control circuit 138.

The first conductive signal terminal T1, in a first predetermined condition, is electrically connected to the first fixed contact 158 and the third conductive signal terminal T3 is connected to the second fixed contact 158′, and in a second predetermined condition, the first conductive signal terminal T1 is connected to the second fixed contact 158′ and the third conductive signal terminal T3 is electrically connected to the first fixed contact 158. The electrical connection between the first conductive signal terminal T1 and the first fixed contact 158 or the second fixed contact 158′ is obtained through the first variable position contact M1 and the electrical connection between the third conductive signal terminal T3 and the first fixed contact 158 or the second fixed contact 158′ is obtained through the third variable position contact M3.

The fourth terminal T4 is connected to the first fixed contact 158 and the second terminal T2 is connected to the second fixed contact 158′, or in a variant, the switching module 10 may comprise a second variable position contact M2, a fourth variable position contact M4 and a second control circuit 138′ arranged to control said second variable position contact M2 and said fourth variable position contact M4; the electrical connection between the fourth conductive signal terminal T4 and the first fixed contact 158 is obtained through the fourth variable position contact M4, and the electrical connection between the second conductive signal terminal T2 and the second fixed contact 158′ is obtained through the second variable position contact M2.

The first control circuit 138 controls the passage from the first condition to the second condition, and vice versa.

The first variable position contact M1, the third variable position contact M3, the first fixed contact 158 and the second fixed contact 158′ are constructed so that, in any positioning configuration of the first variable position contact M1 and the third variable position contact M3, the first fixed contact 158 and the second fixed contact 158′ are always in a condition of electrical insulation between them.

In other configurations, the switching module 10 may comprise a number of variable position contacts and a number of conductive signal terminals, which are variable according to the circuit-breaker, deviator or reverser configuration to be made.

In an embodiment wherein the controlled circuit-breaker 13 is directly connected to the external electrical system IE, the conductive terminals 41 may be the same conductive signal terminals T1, T2, T3 and T4 (see FIG. 12), of said controlled switch 13.

For example, the controlled switch 13 may be, for example, at least one relay, or more relays arranged according to an axis of symmetry and as an alternative to the relays, for example, static switch devices, for example semiconductor devices, may optionally be used.

In addition, the control circuit board 11 may include at least one through hole arranged to allow the passage of the light emitted by at least one luminous device installed on the control circuit board 11. In this way, a user is able to easily locate the points where the commands may be entered even in low ambient lighting conditions. The internal surface of the through hole(s) may be metallized, to allow a better reflection of the light, consequently generating a well-defined visual sensation of said hole shape to the outside of the electrical control apparatus 1.

The control circuit board 11 and the switching circuit board 21 may be printed circuit boards having a substantially rectangular shape.

In a further aspect, the or each switching circuit 80 of the module 10 may be activated/deactivated, that is connected/disconnected manually, or automatically.

The voltage supply module 30 may receive an alternating input voltage Vsl, from which in a way known per se it obtains one or more direct supply voltages for other devices and components of the apparatus 1, distributed through said conductive terminals 95.

In particular, the electromechanical device D1 may perform at least one button or circuit-breaker function with respect to the external electrical system IE, through a command given by a user.

The first control unit 101 and/or the second control unit 100 may also start an activation function of the electrical control apparatus 1 when a command given by a user is detected through an activation conductive area 142, associated with an activation module 120. In this way, it is possible to put the electrical control apparatus 1 in rest mode in the time intervals wherein the user does not issue commands, so as to reduce the consumption of the electrical control apparatus 1.

Furthermore, the electrical control apparatus 1 may comprise a temperature sensor arranged for the detection of the ambient temperature and/or comprise a humidity sensor arranged for the detection of the ambient humidity.

Said temperature and humidity sensors may be arranged on the surface or face of the control circuit board 11, or they may be contained inside the interface modules 151 and/or 152.

The control circuit board 11 may provide a control panel, for example of the tactile type, directly with the front panel 25 or through the interface module 151 and/or 152 with the corresponding touch panel 25″.

In particular, the interface module 151 and/or 152 may also be coupled to the front panel 25, thus creating mixed structures.

The front panel 25 and/or the tactile panel 25″ may for example be made of glass or methacrylate or of electrically non-conductive material and the material of the intermediate layer may be for example bioadhesive.

Openings may be expediently made in this intermediate layer to allow the light emitted by luminous devices (such as LEDs, not shown) to pass through.

In this way, the electrical control apparatus 1, knowing the ambient temperature and humidity, may autonomously control any electrical devices connected to the electrical control apparatus 1, including air conditioners.

For each switching circuit 80 of the module 10 the electronic control module 20 may comprise a respective actuation “key,” for example of the tactile type, which may be actuated through the interface module 151 and/or 152 or the aforesaid “keys” may alternatively be of any other known type, for example mechanical, or replaced with a remote sensor, etc.

Expediently, the control module 20 further comprises a general actuation key for the electrical control apparatus 1 as a whole, independent of the activation/deactivation keys of the individual switching circuits.

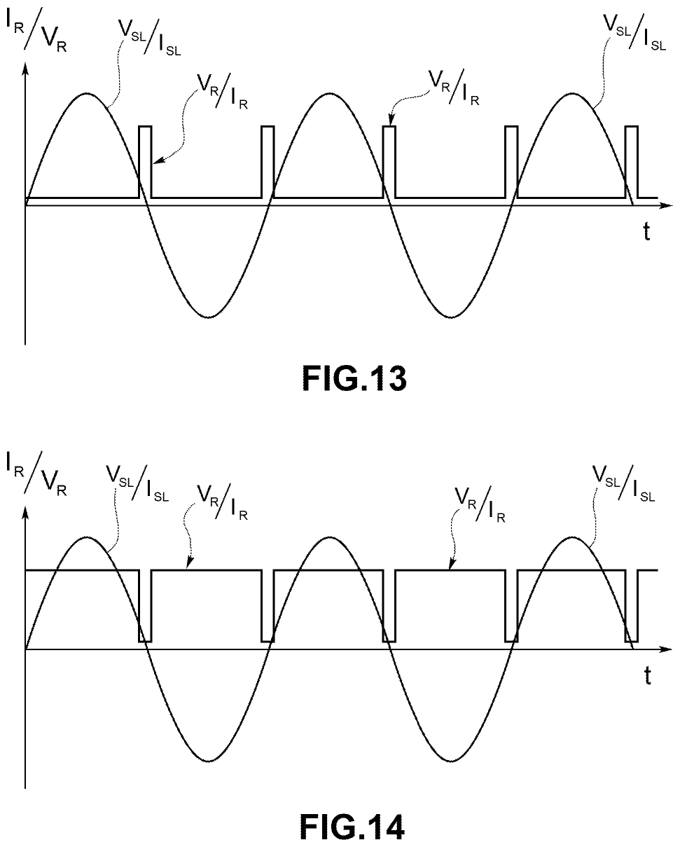

Preferably, but not necessarily, the electrical control apparatus 1 may provide a voltage monitoring circuit 102 arranged to detect the passage of the voltage Vsl of the external electric power line SL at the zero crossing point, which generates a signal for monitoring the presence of the voltage Vr towards the first control unit 101 and/or the second control unit 100,
or, as an alternative to the voltage monitoring circuit 102, it may include a current monitoring circuit 103 arranged to detect the passage of the current Isl of the external electric power line SL at the zero crossing point, which generates a current presence monitoring signal Jr towards the first control unit 101 and/or the second control unit 100 (see FIGS. 13 and 14).

Due to these signals, if the first control unit 101 and/or the second control unit 100 detects the absence of signals from the voltage presence monitoring signal Vr, or from the current presence monitoring signal Jr, for a period of time greater than a predetermined time interval, said first control unit 101 and/or said second control unit 100 brings each controlled switch 13 into a respective predetermined safety switching state, stored in a memory. Due to this function, the electrical control apparatus 1 may bring a home automation system into a condition of security in the event of a temporary or constant power failure.

Expediently, the electrical control apparatus 1 may include multiple electromechanical devices D1 without the voltage supply module 30 and may include multiple electromechanical devices D1 including the voltage supply module 30.

In this case power to the electrical device D2 may be supplied by the various electromechanical devices D1 including the voltage supply module 30.

This solution also allows for the current supply to the electrical device D2 to be increased since said current may be provided by multiple power supplies.

The possibility of having multiple voltage supply modules 30 in the electrical control apparatus 1 is guaranteed by the presence of a diode 106 contained for example on the switching circuit board 21.

In particular, the first control unit 101, by means of a predetermined command to the second control unit 100, may receive the information and/or signals received from the voltage monitoring circuit 102 or from the current monitoring circuit 103, for controlling and/or sending the same signals to other electromechanical devices D1 and/or other electrical devices D2, included in the electrical control apparatus 1.

Furthermore, if the first control unit 101 and/or the second control unit 100, after having ascertained the absence of signals from the voltage presence monitoring signal Vr or from the current presence monitoring signal Jr, for a period of time greater than a predetermined time interval, again detect the presence of signals from the voltage presence monitoring signal Vr, or from the current presence monitoring signal Jr, it may bring each controlled switch 13 into a respective predetermined restored switching state, stored in a memory device.

In this way, the electrical control apparatus 1 may guarantee that when the power is restored, the home automation system is returned to a predetermined configuration and there are no unexpected activations of the various devices that are part of the home automation system.

Expediently, the switching circuit 80 may include, among other mechanical components, at least one coil.

Still by way of example, the passage from the conductive condition to the insulating condition may take place by attraction or rejection of the respective position of a variable position contact by a coil that may be powered with a reference potential and may be controlled via the control terminals 110 (see FIG. 12).

The electrical control apparatus 1 may also contain a circuit which causes a vibration 112 or a tactile sensation 114, generated as a function of the force applied by the user in giving a command.

Still further, the electrical control apparatus 1 may comprise a light level control sensor arranged for detecting ambient light. Said light level control sensor allows, through said first control unit 101 and/or said second control unit 100, both the luminous devices contained inside the control module 20, and the controlled switch 13 to be regulated, so as, for example, to adjust the lights inside a home.

The electrical control apparatus 1 may further include a communication module 104, arranged to transmit or receive radio frequency signals through an antenna A.

In particular, the first control unit 101 and/or the second control unit 100 may be arranged to control said switching module 10 and/or said electronic control module 20, by means of a command received from the communication circuit 104; furthermore the communication module 104 may be used to retransmit the radio frequency signals received by said communication module 104.

Expediently, the communication modules 104 may be housed in one end of the electronic control module 20, leaving the central zone to the operation of the user interface.

In particular, the second internal fixing means 177 of the coupling body 402 may be made in a different and/or alternate way, securing the installation of several side by side electronic devices D2, or alternately upwards and downwards.

This allows maximum spacing between the communication modules 104, included in the respective electronic devices D2, so as to obtain the least possible interference between them.

Obviously, said first control unit 101 and/or said second control unit 100 may control the communication module 104 to send or receive radio signals to/from at least one electronic device 143 connected to the external or remote electrical system relative to the external electric system. In this case, for example, the electrical control apparatus 1, by sending a command to the communication module 104, containing information sent via a suitable protocol, in addition to being able to control a second electrical device connected to the external electrical system IE, may perform a regulator function of a variable generic parameter controlled by a remote electronic device 143, which interprets the information received for example to set a variable parameter value as a percentage of the value received through the aforesaid command. For example, if the electronic device 143 is a lighting device, the first control unit 101 and/or the second control unit 100 may, by sending signals via the communication module 104 to the electronic device 143, adjust the intensity of the lighting of the lighting device.

As an example, the antenna A may be made with electronic components or ceramic components or it may be made with at least a conductive area 160 having a predetermined shape, arranged on any surface or face of the control circuit board 11 or of the switching circuit board 21 or it may be contained in at least one interface module 151 and/or 152.

Furthermore, the signals to be transmitted through the communication module 104 may use the voltage presence monitoring signal Vr, or the current presence monitoring signal Ir as a starting synchronism, and if necessary they may wait for a time Trs to synchronize the start of the transmission with any value of the voltage presence monitoring signal Vr or the current presence monitoring signal Ir.

By way of example, the first control unit 101 and/or the second control unit 100 may deactivate the functions of the electrical control apparatus 1, following the reception of a predetermined deactivation signal received via the communication module for a period of time Tv, or until the respective reactivation signal is received.

The electromechanical device D1 may be contained in a recess in a seat S arranged in a delimitation wall W of a room or in a containment box S1. The external electrical system IE extends into this seat S or S1.

Furthermore, the switching body 2 may include further fixing means 76 included in the cavity 6 intended to block the first cover 32, by means of suitable fixing means 75, for example fins, included in said first cover 32.

Furthermore, the cavity 6 may include a pin 59 (see FIGS. 7 and 15) contained in the cavity 6, intended to fix the switching circuit board 21 in a single predetermined position.

The switching body 2 not only acts as a static container but is also a functional container in which the reference planes are constructed for the optimal positioning of the circuit boards and for the electrical insulation of the various components.

The closure cap 7 of the electromechanical device D1 may include coupling means 79, for example hooks, which lock the same closure cap 7 to the switching body 2 through corresponding fixing means or cavities 89 included on the external part of said switching body 2.

Expediently, the closure cap 7 may include protrusions 82a intended to insulate the conductors of the external electrical system IE and the conductors of the external electric power line SL, guaranteeing the local safety regulations.

The closure cap 7 of the electromechanical device D1 may include dividing walls 86, which form internal cavities 88 intended to contain and separate the various conductive terminals 41, 41a, 41b.

Furthermore, the voltage supply module 30 may comprise a further ground terminal 41b, such as a screw terminal, for making the ground connection. The relevant tightening screw may be manipulated by means of a screwdriver or the like, through a corresponding through opening 42b (not shown) made in the closure cap 7 and the conductor for the ground connection is introduced through a corresponding through opening 40b made in the closure cap 7.

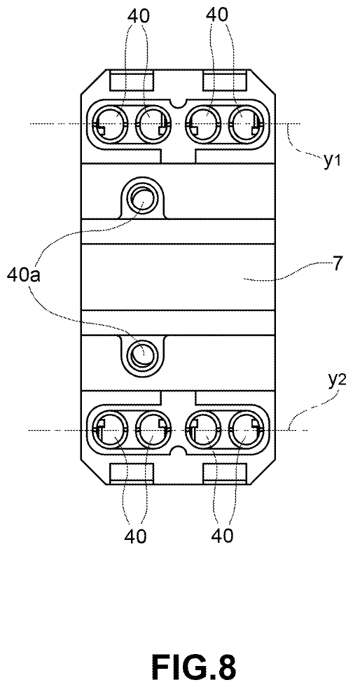

Advantageously, the tightening screws of the electrical power terminals 41a may be manipulated by means of a screwdriver or the like, through the corresponding through openings 42a made in the closure cap 7 and the conductors of the external electric power line SL are introduced through the corresponding through openings 40a made in the closure cap 7 (see FIG. 8).

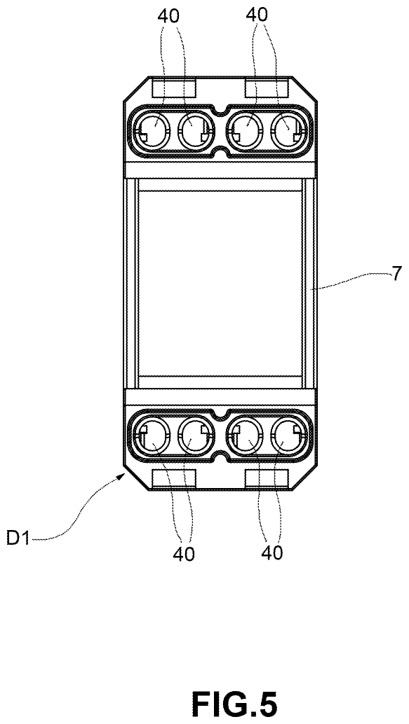

Similarly, the tightening screws of the conductive terminals 41 may be manipulated by means of a screwdriver or the like, through the corresponding through openings 42 made in the closure cap 7 and the conductors of the external electrical system IE are introduced through the corresponding through openings 40 made in the closure cap 7 (see FIG. 5).

If the electromechanical device D1 includes the voltage supply module 30, the closure cap 7 may be shaped so as to also contain this power supply module, for example it may include a further cavity arranged substantially between the protrusions 82a (see FIGS. 6, 7, 9 and 10).

This switching body 2 may be made of an electrically insulating material, for example a molded plastic material.

Expediently, the switching circuit(s) 80, arranged on an internal support 300 (not shown) intended to close the containment structure 4 of the switching body 2 and the second circuit board 21 are pre-assembled together, so as to form a monolithic group, and connected to the switching body 2 by the fixing of said second circuit board 21 to said switching body 2 by soldering the control terminals 110 through a corresponding passage 110′ arranged therein (see FIG. 15).

The coupling support 402 may be fixed to said seat S or S1 by means of at least one fixing element 8, such as a screw or the like, engaged on the external side of said coupling support 402 through a corresponding passage 452 (see FIGS. 1 and 3) or directly to a wall by means such as screws.

Additionally, the electrical control apparatus 1, may include a spacer 502 interposed between the boundary wall W and the coupling support 402 and blocked during assembly of the same coupling support 402 with the corresponding screws or fixing elements 8.

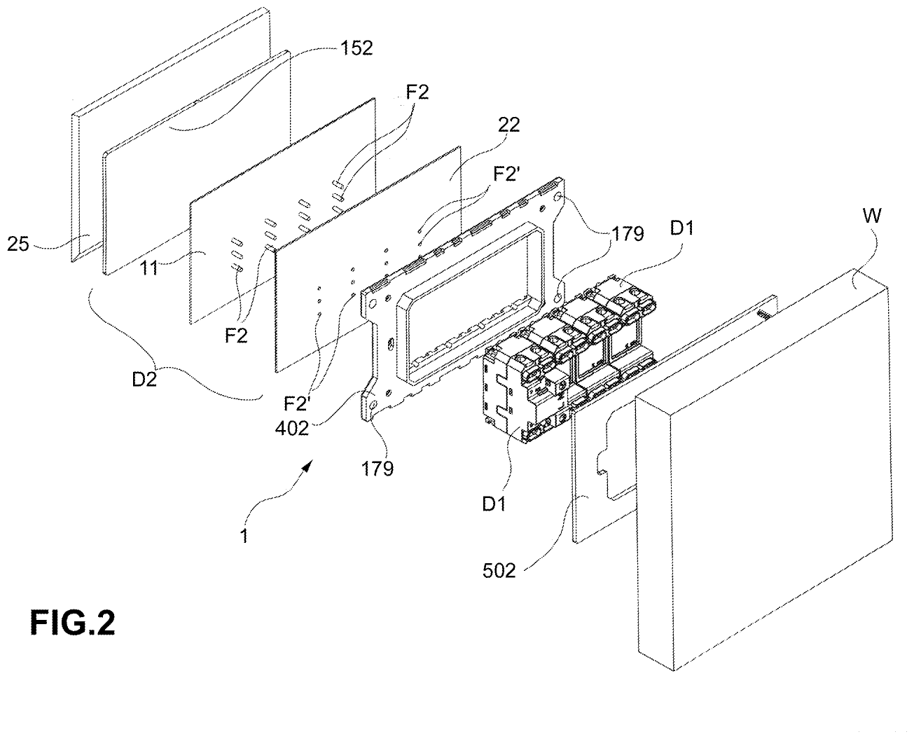

This spacer 502 may be centered with the coupling support 402 through the use of some cones 180, placed for example at the ends of the same spacer 502 and the corresponding conical holes 179 included in the coupling support 402 (see FIGS. 1 and 2).

This spacer 502 may be shaped for example in such a way as to have a quadrilateral or rectangular shape including a cavity 504 intended to allow the electromechanical device(s) D1 present to pass and may possibly overhang the profile of the box S1 emerging from the boundary wall W.

Therefore, the external profile of the spacer 502 may compensate for any installation anomalies also of the box S1, thus creating a better aesthetic appearance of the electrical control apparatus 1.

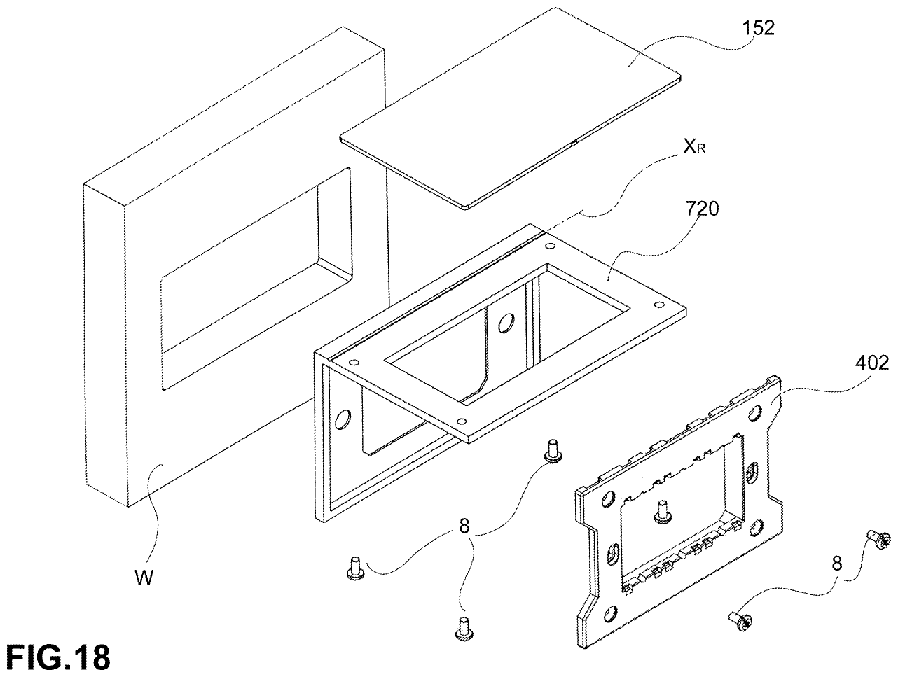

In a further fastening structure (see FIG. 18) the electrical device D2 and the coupling body 402 may be mechanically coupled by means of a mechanical movement system 720. For example, the mechanical movement system 720 is a system that opens and closes like a book.

The mechanical movement system 720 may include a rotation system on an axis XR (see FIG. 18) or it may include a tilting or translating system on special linear guides.

In particular, the mechanical movement system 720 may be fixed, for example by means of fixing elements such as screws 8 or with a mechanical locking system to the electrical device D2 and fixed with other screws or with a mechanical locking system to the coupling support 402 or it may still be locked during assembly, between the wall and the same coupling support 402.

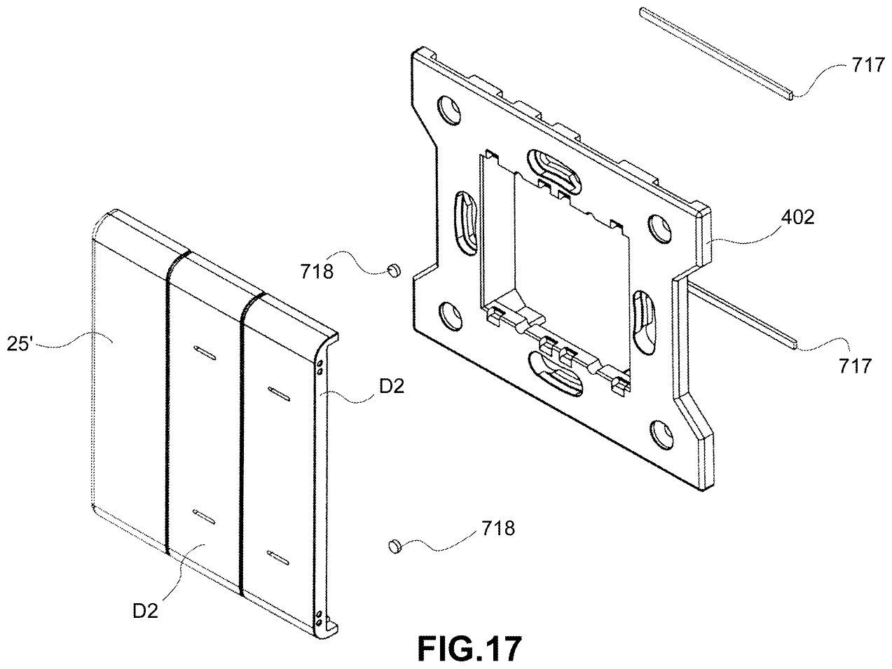

In a further fixing structure (see FIG. 17) the electrical device D2 and the coupling body 402 are mechanically coupled by means of a magnetic attraction obtained by at least one component 718 of ferrous or ferromagnetic material or a magnet contained in the electrical device D2 and by at least one component 717 of ferrous or ferromagnetic material included in the coupling body 402 or even the same coupling support 402 made of ferrous or ferromagnetic material.

In particular, the linear bar 717 may be arranged longitudinally with respect to the first external fixing means 177 and be fixed to the coupling body 402 in a special slot made in the coupling body 402 itself and the component 718 may be fixed inside the electrical device D2.

By way of example, on the external part of the electrical control apparatus 1, a cover plate 25′ of a type known per se may be installed as an additional element of decoration and/or to cover the fastening screws 8.

Advantageously, the electrical control apparatus 1, being made up of two separate devices, allows, for example, for an electrical device D2 having a degree of protection from water or dust greater than the first electromechanical device D1; this guarantees compliance with safety regulations in damp environments, such as kitchens and bathrooms.

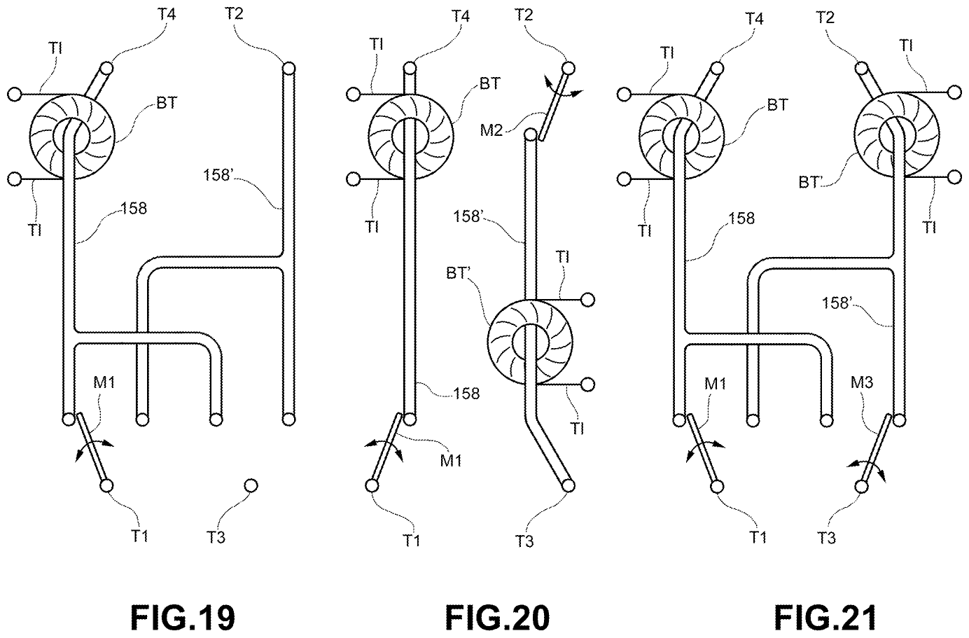

The present invention further relates to an electromechanical device D1 (see FIGS. 19, 20 and 21) wherein the switching body 2 may include at least one toroidal coil or a solenoid wound on a toroidal support or a toroid BT, through the central cavity of which the first fixed contact 158 and/or the second fixed contact 158′ passes.

The toroid BT allows the passage of alternating current in the first fixed contact 158 and/or in the second fixed contact 158′ to be detected by means of a special measurement circuit 119 (not shown) and/or powers the electrical control apparatus 1 completely or partially (for example only the electromechanical device D1), through a special conversion circuit 117 (not shown).

The conversion circuit 117 and/or the measurement circuit 119 may be arranged on the switching circuit board 21 and/or inside the voltage supply module 30; therefore, the inductive terminals TI (see FIGS. 19, 20 and 21) of the toroid BT may thus be connected to the electronic control module 20 or to the voltage supply module 30.

In particular, the conversion circuit 117 and the measurement circuit 119 make use of the laws of magnetism, as already known in the prior art, by using the measurement of the magnetic force field, the magnetic induction field, the electromotive force induced on the toroidal coil, the length of the solenoid, etc., to determine the current passing through the first fixed contact 158 and/or the second fixed contact 158′.

Expediently, the conversion circuit 117 may include an output for the current induced in excess, with respect to its consumption, to be used as a power supply for the electrical control apparatus 1.

The electromechanical device D1 may include a switching body 2 inside of which at least one switching module 10 is housed. The switching module 10 comprises a plurality of conductive terminals 41 which allows the connection of the switching module 10 to an external electrical system IE, and a switching circuit which includes at least one controlled switch 13 which allows a selective implementation of a circuit-breaker, deviator or reverser configuration to said conductive terminals 41 and a first fixed contact 158 and/or a second fixed contact 158′, and at least one toroid BT, having a central cavity through which the first fixed contact 158 and/or the second fixed contact 158′ passes.

The toroid BT is arranged to detect and/or measure the alternating current passing through the first fixed contact 158 and/or the second fixed contact 158′, through a special measurement circuit 119 or through a conversion circuit 117 arranged to supply at least partially the electrical control apparatus 1.

The measurement circuit 119 and/or the conversion circuit 117 use the laws of magnetism to determine the current passing through the first fixed contact 158 and/or the second fixed contact 158′.

The toroid BT is arranged to detect and/or measure the alternating current passing through the first fixed contact 158 and/or the second fixed contact 158′, through a suitable measurement circuit 119 (not shown), which analyzes the induced output current from the inductive terminals TI of the toroid BT, or is arranged to generate an external power supply, through a special conversion circuit 117 (not shown), which generates an output current or voltage based on the induced output current from the inductive terminals TI of the toroid BT in excess, relative to its consumption.

In particular, the conversion circuit 117 and the measurement circuit 119 may make use of the laws of magnetism, as already known in the prior art, and therefore the measurement of the magnetic force field, the magnetic induction field, the electromotive force induced on the toroidal coil, the length of the solenoid, the number of turns, etc., to determine the current passing through the first fixed contact 158 and/or the second fixed contact 158′, analyzing and/or using the current induced at the output to the inductive terminals TI from the toroid BT.

Expediently to reduce the height of the electromechanical device D1, the coil(s) of the control circuits 138 and/or 138′ and/or at least the toroid BT may have a non-circular shape, for example elliptical or substantially rectangular shape.

Herein, where applicable, the features of the embodiments described above for the control apparatus, and not repeated here, are also applicable for the electromechanical device D1 of the present invention.

Various aspects and embodiments of an electrical control apparatus and an electromechanical device according to the invention have been described. It is understood that each embodiment may be combined with any other embodiment.

Naturally, without prejudice to the principle of the invention, the embodiments and the details of construction may vary widely with respect to that which has been described and illustrated purely by way of non-limiting example, without thereby departing from the scope of the invention as defined in the appended claims.

What is claimed is:

1. An electrical control apparatus, comprising:
a coupling support comprising first internal fixing means;
at least one electromechanical device comprising:
a switching body housing at least one switching module; said at least one switching module comprising a plurality of conductive terminals configured to allow a connection of said at least one switching module to an external electrical system, and a switching circuit comprising at least one controlled circuit-breaker configured to allow a selective implementation of a circuit-breaker configuration, or deviator configuration, or reverser configuration at said plurality of conductive terminals; and
a switching circuit board comprising an electronic control circuit of the at least one controlled circuit-breaker and at least one first electrical connection means;
an electrical device comprising:
an electronic control module comprising a control circuit board which comprises at least one second electrical connection means;
said switching body comprising second internal fixing means configured to be interchangeably coupled to the first internal fixing means;
the plurality of conductive terminals protruding from a first side of the switching body and the switching circuit board being on a second side of the switching body, opposite to said first side of the switching body;
said electronic control module being configured to control, by the first electrical connection means and the second electrical connection means associated with said at least one switching module, the at least one switching module as a function of a command given by a user.

2. The electrical control apparatus of claim 1, wherein:
the coupling support comprises first external fixing means and the electrical device comprises a front panel, wherein said front panel, or the electrical device, comprises second external fixing means configured to be interchangeably coupled to the first external fixing means of the coupling support.

3. The electrical control apparatus of claim 1, wherein:
the control circuit board of the electronic control module comprises at least one conductive area; and
the electronic control module is configured to control the at least one switching module as a function of a command given by the user through said at least one conductive area or through an interface module connected to said at least one conductive area.

4. The electrical control apparatus of claim 1, wherein the electronic control module is interchangeably connected to the switching circuit board through said at least one first electrical connection means and at least one second electrical connection means.

5. The electrical control apparatus of claim 1, wherein the at least one electromechanical device performs at least a button or circuit-breaker function with respect to the external electrical system, as a function of a detection of a certain command given by a user.

6. The electrical control apparatus of claim 1, wherein the at least one first electrical connection means and the at least one second electrical connection means are each a snap connector, or one is a connector and the other is a conductive area.

7. The electrical control apparatus of claim 1, wherein the electromechanical device includes at least partially a voltage supply module configured to be connected to an external electric power line through electrical power terminals; the voltage supply module providing at least one direct voltage output configured to power said electrical control apparatus.

8. The electrical control apparatus of claim 7, wherein conductive terminals of said plurality of conductive terminals are arranged on two parallel planes and the voltage supply module is contained in a region of the electromechanical device comprised between said parallel planes;
wherein the electronic control module and the voltage supply module are electrically and mechanically separated from the conductive terminals.

9. The electrical control apparatus of claim 1, wherein the control circuit board comprises a first control unit and the switching circuit board comprises a second control unit; said first control unit and/or said second control unit being arranged to control said switching module via a command given by the user.

10. The electrical control apparatus of claim 1, wherein the switching body comprises a containment structure in the form of a tray, defining a cavity, configured to contain the switching module and may include a containment part in the form of a tray, defining a cavity, configured to contain the switching circuit board and at least one through hole outside the containment structure and inside the cavity.

11. The electrical control apparatus of claim 9, wherein the control circuit board of the electronic control module comprises at least one conductive area, and the electronic control module is configured to control the at least one switching module as a function of a command given by the user through said at least one conductive area or through an interface module connected to said at least one conductive area, and wherein the at least one conductive area is configured to generate a magnetic field or an electric field towards the outside of the electrical control apparatus or to present a predetermined capacity, wherein intensity of the magnetic field or of the electric field or the capacity of said at least one conductive area varies when a command is given by the user by touching said at least one conductive area, or when the user reaches a distance lower than a predetermined threshold from the at least one conductive area; variations in intensity of the magnetic field or of the electric field or of the capacity of said at least one conductive area being analyzed by the first control unit and/or by the second control unit or by a special measurement circuit to detect a given command.

12. The electrical control apparatus of claim 3, wherein the interface module is a display means and includes a touch panel, and/or the interface module is at least one tactile key, assembled by soldering or by a mechanical system for fastening it to the control circuit board, so that at least one electrical conductive terminal of said display means and/or tactile key, is directly connected to at least one conductive area.

13. The electrical control apparatus of claim 1, including comprising a voltage monitoring circuit configured to detect passage of the voltage of an external electric power line at the zero crossing point; the voltage monitoring circuit being configured to generate a voltage presence monitoring signal;
or, as an alternative to the voltage monitoring, said electrical control apparatus comprises:
a current monitoring circuit configured to detect the passage of current of the external electric power line at the zero crossing point; the current monitoring circuit being configured to generate a current presence monitoring signal.

14. The electrical control apparatus of claim 1, comprising a temperature sensor for detecting ambient temperature and/or a humidity sensor for detecting ambient humidity and/or a sensor for controlling level of light.

15. The electrical control apparatus of claim 1, comprising a communication module configured to transmit or receive radio frequency signals via an antenna.

16. The electrical control apparatus of claim 15, wherein the communication module is housed in one end of the electronic control module.

17. The electrical control apparatus of claim 1, comprising a vibration means configured to generate a vibration or a tactile sensation means configured to provide a tactile sensation which is a function of a force applied by the user in giving a command.

18. The electrical control apparatus of claim 1, wherein the electrical device and the coupling support are mechanically coupled via:
a mechanical movement system including a rotation system or a pivoting or translational system; or
a magnetic attraction system including at least one component of ferrous or ferromagnetic material; or
a magnetic attraction system including a magnet contained in the electrical device and at least one component of ferrous or ferromagnetic material included in the coupling support; or
a magnetic attraction system including a magnet contained in the electrical device and the coupling support is made of ferrous or ferromagnetic material.

19. The electrical control apparatus of claim 1, wherein an orientation of the electrical device is independent from the orientation of the electromechanical device coupled to the coupling support.

20. The electrical control apparatus of claim 1, wherein the switching circuit comprises a first fixed contact and/or a second fixed contact and said switching module comprises at least one toroid having a central cavity through which the first fixed contact and/or the second fixed contact passes;
said at least one toroid being configured to detect and/or measure an alternating current passing through the first fixed contact and/or the second fixed contact, by a measuring circuit or,
via a conversion circuit configured to at least partially supply the electrical control apparatus;
said measuring circuit and/or said conversion circuit being configured supply to use laws of magnetism to determine the current passing through the first fixed contact and/or the second fixed contact.

21. The electrical control apparatus of claim 1, wherein selective implementation of a circuit-breaker configuration, deviator configuration or reverser configuration to the conductive terminals is applicable partially, or totally, or even so that a total separation of said conductive terminals from the switching circuit is achieved;
with total application of a circuit-breaker configuration, deviator configuration or reverser configuration to the conductive terminals, the configuration for which it has been designated;
with partial application of a circuit-breaker configuration, deviator configuration, or reverser configuration, the switching circuit varies internal switching configuration and applies it to the conductive terminals, even by permuting the conductive terminals;
with application of total separation of a circuit-breaker configuration, deviator configuration or reverser configuration, the switching circuit does not apply conductors, the configuration for which it has been designated, while maintaining said switching circuit internally, which is controlled, but not applied to the conductive terminals.

22. An electromechanical device comprising a switching body housing at least one switching module;
said switching module comprising a plurality of conductive terminals configured to allow a connection of said switching module an external electrical system, and a switching circuit comprising at least one controlled switch configured to allow a selective implementation of a circuit-breaker configuration, or deviator configuration, or reverser configuration to said plurality of conductive terminals and a first fixed contact and/or a second fixed contact and at least one toroid comprising inductive terminals and having a central cavity through which the first fixed contact and/or the second fixed contact passes;
said toroid being configured to detect and/or measure an alternating current passing through the first fixed contact and/or the second fixed contact, through a measuring circuit, which analyzes the induced current exiting from the inductive terminals of the at least one toroid, or being configured to generate an external power supply, through a conversion circuit that generates a current or voltage output, based on the induced current exiting from the inductive terminals of the at least one toroid in excess with respect to its own consumption.
